(19) United States
(12) Patent Application Publication
(10) Pub. No.: US 2022/0366276 A1
(43) Pub. Date: Nov. 17, 2022

(54) Advanced_Value_Profile_Analysis_Deliverables_and_Applications

(71) Applicant: Robert Kinsel Smith, Dallas, TX (US)

(72) Inventor: Robert Kinsel Smith, Dallas, TX (US)

(21) Appl. No.: 17/319,736

(22) Filed: May 13, 2021

(51) Int. Cl. G06N 5/04; G06N 20/00

(52) U.S. Cl. CPC G06N 5/04; G06N 20/00

(57) ABSTRACT

This invention adds analysis and reviews of valuations, compositions, transpositions, variances, ratios, and their relationships to one another, to the scoring, and describing of a person's value structure. Going beyond the historic focus on the values scores, it provides significantly greater precision and applicability of value profiles by including analysis of the component parts of the value scores and the relationships of those components to the other scores. Besides the more comprehensive analysis, this invention will create a hierarchy of importance of the user's thinking orientations, computing both the rarity and proximities to the axiological order of the thinking elements and relationships. This has been designed for use with personal tech devices to provide personalized counsel, advice, and training, both for direct user use and for use by professional reviewers. Helping professionals (health care, security, teachers, etc.) will be able to be trained and certified online, enabling more effective communication with their clients, patients, citizens, and students.

### CROSS-REFERENCE TO RELATED PATENTS

This application is related to, and contains common disclosures with U.S. Pat. No. 6,338,628 B1, “PERSONAL TRAINING AND DEVELOPMENT DELIVERY SYSTEM”, and U.S. Pat. No. 6,618,723 B1, “INTERPERSONAL MOTIVATIONAL COMMUNICATIONS SYSTEM”, having the same inventor and owner, Dr. Robert Kinsel Smith. The related patents are hereby incorporated by reference into this description as fully as if here represented in full.

### BACKGROUND OF THE INVENTION

The present invention relates in general to computer-based training (CBT) and personal/professional development systems, and more particularly, to a personal tech device-implemented coaching, personal development, and advising system.

Since the first two patents were granted in the early 2000s employing formal axiology (value science), companies around the world have used the Clear Direction, Inc. products generated by the technologies of those two patents. Now the marketplace's embracing and relying upon the Internet, smart phones, personal tech devices (smart watches, fit bits, ear buds, etc.), Apps, and Agents (Ski, Alexa, etc.) have both made more platforms possible and have made use of electronic devices common. Business professionals and consumers have grown to rely on these and readily embrace advances in their applications.

Secondly, the common perception concerning the shortening of the attention spans of Americans over recent decades is supported by the empirical evidence that people do not favor printed reports as they did previously and do not spend time or give much effort to learning things that are not immediately applicable.

Thirdly, video use on personal devices grew from 15% in 2013 to 45% in 2019 with countless sites, publications, and contests touting that videos ought to be only 7 seconds long. Between the observed changes and trends in consumers' activities and the demands we receive from clients, we have become convinced that resources that will be employed by today's adults are ones that provide immediate answers to present problems, brief high-action videos, advanced integration of machine learning and personal tech devices, and bullet-point advice and examples for personal and professional use and development.

For the past two decades Clear Direction, Inc. has provided printed reports explaining and detailing the results of clients' value profiles (the detailed process and description of these is found in the first patent application). The first reports were 155 printed pages in length. Because of client demands, in 2002 Dr. Smith reduced the size of the reports to 60 pages in length with 6 page electronic lessons (the first of his patents) sent to users via email over a six month period. With continual requests for greater simplicity, Dr. Smith developed a 19 page report in 2015, which has become Clear Direction's best-selling product.

Now clients are demanding even shorter ‘reports’ that are accessible electronically (for personal tech devices) and that employ the most advanced applications of technology (video, Agents, smart watches, etc.). This new level of brevity has required that the software precisely generate information from a user's profile results that heretofore has not been required. This level of precision from the scoring software has not previously been required because professional profile reviewers have interpreted, provided, and explained volumes of information to each user. Secondly, the interpretation algorithms (the scores and information are generated) used to date focus on the characteristics of each of the individual dimensions of value and only occasionally touch on how the clarities of those thinking dimensions gain their characteristics and meaning from how they interact and how they are inter-related. The comparisons heretofore have primarily only been with the user's rankings of the values with the axiological rankings, with the other comparisons noted in this application being overlooked and ignored.

Dr. Hartman, the founder of formal axiology, regularly emphasized that every profile ‘score’ was the result of how the user viewed the three dimensions in relation to one another. But the scoring and reports to date have emphasized each dimension's individual scores in relation to their axiological rank, marginally touching on any relationships to the other dimension capacities, and ignoring other important elements and relationships. This invention measures, reports, and prioritizes the inter-relatedness of each of the perspectives of the user from newly designed scoring algorithms and scores that represent and model the dynamic nature of the user's thinking. These are derived from and describe the dimension scores in light of their capacities and biases together, their relationships to the other dimensions, to the other field of reference, to the actions upon the values, and to user's differing views of the nature of values when acted upon constructively and destructively.

### A Brief Review of Formal Axiology

Formal axiology (value science) is a logical system that defines the terms of how people think and models how those terms interact and relate to one another for a person to make a decision. The terms define the different ways and properties of how a person can know something, another person or themselves. The modeling of those different terms employs transfinite calculus, a mathematical system that has sets with the same properties as the three dimensions of value. While different value scientists have argued that other mathematical models could be used, it is this author's conclusion that Dr. Hartman's use of transfinite set theory accurately models the logical system of value science and provides results that have proven to be highly reliable.

Since 1966 a value profile has been used to model a person's valuing (thinking, prioritizing, deciding). The resultant model is called a value structure. It provides scores on different number scales that represent the extent to which the subject valued each different dimension and how the subject related the different dimensions to one another. Dr. Robert S. Hartman and others developed algorithms that led to models of how those different ways of thinking interact for each individual, based on their final rankings. Since the 1960s, individuals have completed a value profile and then received a personal report, accompanied by a professional's review of that report. The personal nature of the information along with the complexity of concepts made it difficult for a participant to get useful information from their reports without a professional's help. How a person values and how that applies to his/her life is full of complexity and is actually composed of ideas that are not commonly considered or discussed.

The value profile has been improved over the decades with the most culturally up-to-date and tested profile being the Hartman-Kinsel Profile (cf. Patent 6338628 B1). All of Clear Direction, Inc.'s profile reports are generated from the results of the user completing the Hartman-Kinsel Profile. Back in the mid-1990's professional axiologists were expressing doubts as to whether a report could be constructed that did not require a professional's face-to-face interpretation. Professionals then concluded that most subjects' own ideas about themselves coupled to the difficulty of thinking about one's own thinking made it very difficult (if not impossible) to design a ‘report’ that would be informative and useful to these users.

In 2002 and 2003 Dr. Robert Smith was granted two patents for technologies employing formal axiology that generated useful reports. The first designed and generated ongoing lessons, based on each person's individual value structure, that addressed either their development as an employee or as a manager in business. The second patent provided personalized information to a manager on how best to lead his/her team, how he/her could manage more effectively in light of his/her own thinking biases, and how best to manage and communicate with each individual direct report. While these reports were not dependent upon professional reviews, they were still most useful when they were supplied with a professional review.

### The Value “Test”

As described in the first patent, each page of the profile test contains 18 different statements/terms that contain a different value and a valuation (action upon or characteristic of the value).
In order to rank these terms (that are formal representations of each of the value combinations) the user uses his/her ways of thinking to determine what those mean and how they compare to one another. Originally these tasks were completed with paper and pencil and by 1999 they were completed on computers connected to the internet. With the advancements in software and hardware, the options with which a user completes the value profile are greater, including personal computers and tablets, Agents, smart phones, and virtual headphones

Cognitive sciences tell us that these different dimensions of value are handled by different parts of the brain and therefore, like our senses, each person can have a different ‘formula’ of thinking depending on which brain regions have developed and are used. The output derived from the participant's ranking includes how that participant preferred the properties of certain dimensions over the properties of other dimensions, how consistently those preferences were displayed (versus significant reactions in specific cases), and how those preferences and consistencies relate to one another.

### Values and Valuations

In value science, the value is the noun and the valuation is the adjective or verb (qualifier) acting upon the noun. When the valuation is consistent with the properties and characteristics of the noun, then it adds value to that noun (like putting antifreeze in a car's radiator). When the action or adjective is inconsistent with the properties or characteristics of the noun, then it is a transposition, taking value away from that noun (like putting mud in a car radiator). The list of value combinations is 18 items, composed of three dimensions with three compositions on each and three transpositions on each, making a total of 18.

### A Brief Review of the Components of Formal Axiology

The following components are contained in the following algorithms (again explained in significant detail in the first patent application).

Dimensions of Value: Dr. Bertram Russell identified three ways that humans know things: intrinsically (singularly), extrinsically (empirically), and systemically (conceptually). In the 1950s, Dr. Robert Hartman formally defined these three dimensions of value as:
Intrinsic: Singular value, being non-denumerable properties, coming from an infinite set of possibilities.
Extrinsic: Empirical value, being denumerable properties coming from an infinite set of possibilities
Systemic: Formal value, being denumerable properties coming from a finite set of possibilities.

Because Dr. Robert Hartman (1940s) formalized the definitions of these terms, he was able to develop a formal system and the profile test, as described above. The first list on the test represent the world outside one's self (how we know things and other people). The common terms for some of this valuing include: empathy, tangible outcomes, logic, law, order, results, and sympathy. The second list on the test represented the three dimensions applied to one's self. Common terms for these kinds of knowing include: self-esteem, self-awareness, self-expectations, confidence, courage, resilience, and stubbornness.

Values are the nouns in the test's lists of statements. The three dimensions are identifiable by the elements in the definitions of the dimensions of value. Examples of these are: a person is intrinsic, a car is extrinsic, and a plan is systemic. In value science terms we would say that a person is intrinsic (singular), the person's body is extrinsic (empirical), and the person's ideas are systemic (formal constructs). Examples of values (nouns) in the tests include: baby, car, uniform, sign, ticket, mother, and food.
Valuations are the adjectives or actions which modify the values. Again these are definable in accordance with the definitions of the dimensions of value. Again, simple illustrations of these are: ‘life-saving’ being intrinsic, ‘useful’ being extrinsic, and ‘logical’ being systemic.

Compositions are valuations that are adjectives or actions acting upon the value (the noun) that increase the value of that noun. These are actions or properties that apply or enhance the noun. For example, a tablespoon of cream enhances a cup of coffee (for most people), so a cup of coffee with cream would be a composition.

Transpositions are valuations that are adjectives or actions upon the noun that reduce the value of the noun. These actions are ‘out of sync’ with the noun. An example of a transposition is ‘breaking a television with a hammer’. We can see that destroying a television may be a constructive action for the parent of a young child who wants to spend his entire day watching TV but in relation to the purpose and properties of televisions, breaking one with a hammer is an action that reduces that TV's value as a TV. Other transpositions include ‘hatred’ (intrinsic disvaluation), ‘destroying’ (extrinsic disvaluation), and ‘confusing’ (systemic disvaluation).

### ‘The Good’ and ‘Better’

Dr. Hartman identified that an axiom of value is the description of ‘the good’. That axiom is, “Something is good if it fulfills its definition.” A car is good if it is full of car properties while another car is fair if it has a few car properties. This definition led to Hartman defining ‘better’ as the thing that is ‘richer in properties’. This ‘richer’ is not a linear or arithmetic summing of the number of properties, but is that which has a greater combination of properties where their interaction results in that thing being richer or better than the others. The eighteen statements in a profile test (as listed above) are comprised of compositions and transpositions of each dimension with each type of valuation acting upon those. Because each dimension has a mathematical value (intrinsic=infinity to the infinite power, extrinsic=finite number to an infinite power, and systemic=finite number to a finite power), the different values with their valuations can be ranked numerically. This is called ‘the axiological rank’ with’ I to the power of I” being the biggest number (infinity to the infinite power to the power of infinity to the infinite power) while ‘I sub I’ is the smallest number (infinity to the infinite power to the negative power of infinity to the infinite power). Hartman used the sets in transfinite set theory to position all of the combinations in relation to each other and then added more distinction by noting (in practice) that the infinity of the intrinsic dimension is greater than the infinity of the extrinsic dimension, and so forth. He listed this axiological ranking in his book, The Structure of Value and Dr. Smith furthered this work in ranking in his book (2007), Writing a Value Profile.
Dimensional Clarity is the consistency with the axiological rank of each of the nouns of the same dimension. When a participant's rankings of the six nouns in the test are consistently ranked in relation to the axiological rank, then the participant has demonstrated an ability to rank the statements without significant bias (not reacting or fixating on other things). When those rankings are far from their axiological position or some of them are ranked significantly differently from the other values of the same dimension, then the person's thinking about things of that dimension is unclear (due to a reaction or inability to see the values, valuations, or both). This can be likened to eyesight, where a person may be able to see clearly with one eye while being unable to see any detail with the other. Or it can be like being able to see great detail when objects are close and unable to see those same detail at all from a distance.

Thinking clarity is the ability to see and distinguish the elements of that dimension with clarity. People with unclear thinking are perceived to be stubborn, for they are unwilling to consider new ideas (data points) and apply them to their decision making. When a person has high thinking clarity, he is able to think about the new data, see how that new data does and does not apply, and is then able to integrate that data into a new idea, conclusion or decision.

### Computing the Profile Report (Dimensional) Scores

As outlined in the first patent, I combined the dims (the numeric scores representing the clarity of thinking for that particular dimension) and percent positive bias scores that Dr. Hartman developed to derive a profile report score (which I also call dimensional scores). This report score (introduced in the first patent) represents the combination of how the participant values things in that particular dimension (how biased toward or away from things in the dimension) with how consistently that person's rankings ranked in comparison to the axiological ranks for those value combinations. These report scores range from 1-10. The matrix of scores used to assign these report scores is in the first patent. So the one number represented these two aspects of the person's value scores. I called these scores ‘profile report scores’. I created these because users found it very difficult to understand two different descriptors about each of the three world and three self dimensions. These profile report scores range from 1-10 with 6 being the center point of the scale. The closer the score is to six (5, 6, or 7), the clearer the thinking. Scores higher than 6 indicate a positive bias and lower than 6 a negative bias. So a score of 9 is a positive bias with poor clarity, and a score of 4 is a negative bias with a moderate clarity. A critical element in understanding the scoring is to remember that the biases and clarifies arise from how the participant ranks the statements in relation to each other and then how those rankings compare to their position in the axiological rank.

### Explaining Each of the Six Individual Profile Scores

Historically the individual profile scores essentially stood on their own. An E2=8 was described according to what an 8 would indicate for extrinsic self valuing. The descriptions would not include how other thinking orientations may/could/do affect that thinking orientation.

Three other scores are historically presented in the Clear Direction reports. The first is the Types of Reasoning, which identifies if the participant ranked transpositions as compositions (and vis versa) and if so, how many times. Scores above 5 are fairly uncommon (fewer than 3% in the US population) and indicate thinking that is so out of the norm that those persons benefit by having their differences explained.

The second additional report score is Attention Balance. This is computed by comparing the scores and relationships of those scores to each other and to the axiological rankings to both the world thinking and self thinking. The outer ranges of this scoring scale indicate inner-directed (0.3) and outer-directed thinking (3), which are explained in the participant's report.

The third set of scores is an invention of Dr. Smith in the 1990s. It is derived from using the rankings of the valuations instead of the values in order to compute the scores. In other words, what looks like a score describing the user's valuing of things, other people and one's self, the score describes the user's valuing of different types of actions or descriptors (that are categorized by the defined nature of the three dimensions). Pertaining to objects and others, these can include adjectives like loving, useful, logical, irrational, personal, destructive, etc. Pertaining to one's self these can include confident, resilient, courageous, insecure, fearful, determined, persistent, insistent, etc. When these valuation biases are opposite the value biases for the same dimension, then those differences are reported and explained in the Clear Direction reports.

### A BRIEF SUMMARY OF THE INVENTION

This invention includes formal definitions of terms and algorithms for the coding of software. These apply to the measuring of and establishing scoring for elements that comprise a person's thinking, inventing and recording scores that represent relationships of those elements with each other and with the corresponding thinking elements, logic that enables computer code to be written that analyzes and records the relationships of these different elements of a person's thinking (that is employed while taking a value profile), and logic that identifies and assigns text file descriptions of how those relationships impact the user's decision making and actions. With these results, of a much more specific and precise modeling of the user's thinking, the technology will also be able to prioritize the importance of that user's different thinking orientations (represented by the different scores), and provide accurate descriptions and precisely targeted counsel, resources, and training and development.

It is an object of this invention's author to maximize the benefits from a value profile, providing descriptions, models and automatic personal reviews of a user's value structure by use of this more robust analysis and the advanced algorithms employed with advanced technologies. With significantly more reliable and precise content, utilizing the advances in machine learning and agent technologies, and being designed for use on the most favored tech tools, it is our goal that our products be applied to problems heretofore out of the reach of value profile based products and that they be embraced above all those considered to be competition.

This new technology employs machine learning, which will generate accurate prioritization of the different thinking elements and relationships of each user's thinking, thus improving explanations, examples, counsel, and training and development to each individual. The user's resources will be available in print, electronic text, audio, and video formats. This invention makes precise feedback possible, descriptions and advice in desired short, bullet-point lengths and makes it possible to effectively use Agents or agent-like robots (avatars, virtual reality characters, or pocket “advisors”) as profile reviewers. Users will be able to have access to their own personal, profile reviews and data anywhere there is internet connectivity, without needing to speak to a trained professional. Additionally, this advancement will make it possible to effectively train and test professional profile reviewers electronically, increasing availability while reducing the costs and improving the quality of the professionals using these products with their clients.

### The Basis of the Invention

This basis of this invention has three major elements. The first is the analysis of elements of the user's thinking (demonstrated in scores for the items and for the relationships) that heretofore have been overlooked or ignored. These elements and relationships will be explained fully in the next section and an example immediately follows.

Secondly, is the development of the algorithms that identify, measure and explain how the different elements of a user's thinking interact with, relate to, and affect one another. Again, these algorithms will be explained fully in the next section and an example immediately follows.

Thirdly, these algorithms will keep track of and analyze the frequencies of the scores, measure them against the axiological ranks, and make running adjustments concerning what constitutes rare thinking combinations. From this it will compare all the user's thinking scores and combinations, and select and rank those scores in light of those master lists, and then generate an order for reporting that user's scores according to the priority ordering noted later in the detailed description of the invention. This ‘machine learning’ will far surpass what any professional reviewer could ever accomplish, because the rarities will be determined objectively, will compare thousands of scores and relationships to other scores, and will continually update the occurrences and frequencies at the same time. The algorithms for this are described in detail in the software logic section of this application.

### An Example of the First Noted Improvement: Identifying What Makes Up a Person's Value Scores

For managers and athletic coaches, knowing the composition of a person's confidence can be very helpful. Historically a profile report primarily reviewed a user's value elements. It would tell if a person has natural confidence but did not tell what made up that confidence. In reality each profile value score that indicates confidence is a combination of compositions and transpositions, which can actually be made up of different combinations while resulting in the same general confidence score. Here are four different combinations that result in the same overall positive value score of 8.

Person A with extrinsic self profile value-based score of 8 could have all positive/optimistic compositions and transpositions, adding up to an overall positive bias.

Or Person B with this score of 8 could have all positive/optimistic compositions with a few negative/skeptical transpositions, adding up to an overall positive bias.

Or Person C with this score of 8 could have a negative/skeptical compositions with a stronger ranking of all positive/optimistic transpositions, adding up to an overall positive bias.

Or Person D with this score of 8 could have both positive/optimistic and negative/skeptical compositions and transpositions, adding up to an overall positive bias.

Here are the four different combinations of compositions and transpositions resulting in an extrinsic self profile score of 8 with descriptions of the differences based on the internal differences of those scores of 8:

| | Today’s General | | |
|---|---|---|---|
| | Description of an | | |
| All have E2 = 8 | E2 = 8 | Compositions | Transpositions |
| Person A | Confident, initiates, cares | All +: “I can do good, | All +: It’s bad to lose, to be |
| | how s/he appears | be useful, make a | embarrassed in public, or |
| | | contribution, and I am | to be seen as not capable. |
| | | confident I can do it and | |
| | | can win. | |
| Person B | Confident, initiates, cares | All +: “I can do good, | Mostly −: I should not take |
| | how s/he appears | be useful, make a | the initiative, I am likely to |
| | | contribution, and I am | make a mistake, lose, or |
| | | confident I can do it and | have someone do better |
| | | can win. | than I can. |
| Person C | Confident, initiates, cares | All −: I can’t do it, I am | All +: It’s bad for me to |
| | how s/he appears | not good at what I do, I | lose, to be embarrassed in |
| | | might make a mistake | public, or to be seen as not |
| | | | capable. |
| Person D | Confident, initiates, cares | Two − and One ++: | Two − and One ++: |
| | how s/he appears | Varying displays of | Varying displays of being |
| | | initiative, wanting | passive, not wanting to get |
| | | recognition with | recognition, with moments |
| | | situations where s/he is | of defensiveness, and |
| | | embarrassed and quiet. | drive to win. |

### An Example of the Second Noted Improvement

Historically any relationship analysis has been evaluated according to the value clarity scores in relation to their axiological rank. The relationships of compositions, transpositions, valuations, values within the same frame of reference, values in relation to corresponding frames of reference, and the effect of the overall thinking patterns on individual value scores have not been analyzed, scored or included in a profile report. This invention includes algorithms that will enable us to have the computer analyze, evaluate, score and record these relationships.

Here are two examples the increased precision of the invention provided. The first is an example of how reports with the new art will not present two people to be the same, when they actually act and decide differently. The second is an example of how the precision gained by the new art could be used by therapists to precisely develop therapies targeting what needs to be addressed in their patients.

Example 1: A married couple both had profile report scores of 7,4,8 4,4,8, so the printed reports generated by the software employing the old art were identical. With the addition of the new art's scoring and measuring of valuations, significant differences are apparent.

The husband's valuations are 4,4,7 4,4,9 and the wife's valuations are 4,7,9 4,4,7 (these valuation scores are the combination of the bias and clarity of the valuations). Two significant differences between these two are now obvious. The wife's highest valuation is her systemic world thinking (rules, order, principles, logic), which indicates that she will prefer that things, people and herself be logical and orderly, and when that is not the case with other people, practical successes, or how the police and news media are acting, she will devalue those things because they are not fulfilling the systemic ordering that she values. Her husband's highest valuation score is his self systemic thinking (9), which means that he first and foremost wants everything to be consistent with his own personal principles, values, and standards.

Secondly, these two differ in that the wife will display her love to others both extrinsically (doing things for others as acts of love—shown in her second valuation score of 7) and systemically (being responsible, dependable, and trustworthy—shown in her third valuation score of 9). She also differs in that her world extrinsic valuation of 7 is positive while her extrinsic value score of 4 is negative. So she will present herself as a person who wants others to get into action and do something, while she actually is skeptical and cautious about them doing just that! The husband's valuations indicate that he will show love by being responsible, dependable and trustworthy, which are indicated by both of his systemic valuation scores (his third and sixth scores of 7 and 9). He will not indicate that he wants people to get into action until enough analysis has been done to satisfy his systemic thinking requirements.

Example 2: A therapist's patient is a wife and mother with very low self-esteem (present profile self intrinsic score of 2). All that the prior art indicates is that this woman does not value her/himself intrinsically. This invention enables us to identify the components of this woman's dismissal of her self-esteem, enabling the therapist to target the problematic thinking. Here are four composition and transposition combinations translated into descriptions of the woman's thinking that lead to her low self-esteem:
I do not believe it is good to treat me as a special person (thus we have a person who avoids at all costs celebrations of her birthday and has difficulty with intimacy).
I do believe it is appropriate for a person to harm me and treat me as though I'm a loser (thus we have a person who believes that being abused is appropriate).
I do believe it is good to tell me how special I am while you also beat me up because I deserve to be treated poorly (so we have a women who defends her physically abusive husband).
I do believe it is bad to actively mistreat me while it is good to not treat me kindly (here we have a person who pushes away others who are kind to her).

### An Example of the Third Noted Improvement

Historically reports generated from the prior art generated pages of scores which a professional reviewer would interpret to their clients. Then this author developed printed reports from that art that described the value scores of the user's value structure, descriptions of the user's thinking preferences under different levels of stress and input, and applied those to specific roles: being a manager, a lawyer, a coach, and as an individual contributor. This present invention erases two weaknesses with the prior methods.

First, the selection of what constitutes the most important or significant elements of a person's value structure will not be determined by the reviewer. The new art will accurately determine what constitutes significant elements with objective, up-to-date analysis of frequencies of averages and ranges for standard deviations from the norm. This order is described in detail later in this application.

Secondly, the new art will measure hundreds of more elements and relationships, making the information much more precise and robust. An example of this is seen in the following:

Example: An executive's value profile report scores are 7, 4, 8, 5, 3, 8. While none of those scores is extremely noteworthy, a professional reviewer would focus on his 7 and 5 because those are the two scores closest to axiological rank and will comment about the 3 because it is the farthest from axiological rank. Exceptional reviewers might even discuss the distance between the 3 and the 8, while the report would not describe that in print.

Applying this new invention reveals two things that are particularly noteworthy and valuable for this executive to know. The first is that his valuation scores are 3, 3, 9, 3, 3, 9. People throughout his professional history had commented that he was not a caring manager. His promotions were delayed because his direct reports thought he was too black and white, too by the book, and did not care for anything except everything being done ‘right’. This feedback was offensive and confusing to him because he wanted to be a manager above reproach and on the inside he genuinely cared about each of his direct reports. His valuation scores indicate that he would show concern and compassion by doing what is right, demanding things be fair, and that he be dependable and trustworthy. He did not realize how he cared for others was inconsistent (and therefore unsuitable for the task) with the intrinsic properties of the caring that he genuinely had.

The second aspect of his profile that would be revealed by the new art is that he had ‘perfect’ ability to see errors (his transposition scores were all axiologically perfect). Because people talk about what they see, he would always talk about the errors that he saw. When he would review another's work, he would pull out his red pen and ‘fix’ the errors. When a direct report made a presentation, he would critique it that same day. When others presented ideas of how to proceed on a project, he would point out the errors in their thinking. What he did not realize is that he thought differently from others and could see errors in ways that they did not see.

This new art gives valuable definitions and realizations to users that have not been previously available from value profiles.

### What the New Art Identifies:

1. how the dimensional score is affected by the user's view of that dimension in the other frame of reference,
2. how each dimensional score and valuation score is affected (or not affected) by the user's frames of reference in relation to one another,
3. how the dimensional score is effected by and understood in terms of the types of the actions upon it (valuations),
4. how the dimensional score and the valuation score is understood in light of which elements each of the biases and clarities are comprised (compositions and transposition),
5. how the dimensional report score and valuation score are affected by and relate to the user's perspectives of all of the different dimensions that are compared,
6. obscure thinking relationships and their frequencies,
7. the best way to prioritize the key elements of each individual's thinking, by measuring:
   their proximity to the axiological patterns and relationships,
   their non-congruence to the axiological patterns,
   the effects of the scores upon one another, and
   the rarity and distinctiveness of those ways of thinking in the marketplace.
8. analysis of the frequencies of thinking combinations (scores and relationships) for an up-to-date, ever adjusting recording of those frequencies and identification of rare thinking orientations, and
9. how to translate the new scores and relationships into text fields that are meaningful to users and profile reviewers.

### THE KEY ELEMENTS OF THE INVENTION

### 1. Scoring and Noting the Effect of the Same Dimension's Score in the Other Frame of Reference

Each frame of reference (world and self) includes intrinsic, extrinsic, and systemic scores. The corresponding dimensional scores represent thinking about things and people with those types of properties. While professional reviewers may have noted how a user's intrinsic profile score in the world frame of reference compares to that user's intrinsic self profile score, this relationship and its effects have never been measured, scored or reported. We will call these Comparison scores, of which there will be one for intrinsic value, one for extrinsic value and one for systemic value.
An example of the importance of this measurement is found when two different users have the same intrinsic world score of 7 but have differing self intrinsic scores of 3 and 9. While they both are thinking similarly about intrinsic value as it compares to the extrinsic and systemic value in their world frames of reference (thus both having scores of 7), their intrinsic experiencing is very different. The user with the 3 will tend toward being sympathetic toward other individuals because of how the self intrinsic valuing compares to valuing others intrinsically. The other user will rarely flow into sympathy because that user's self intrinsic bias is much stronger than the world intrinsic bias.
   2. Scoring and Noting the Effects of the User's Overall World vs. Self Orientations

While the tests do not require that the user directly compare world and self values, how the users view and employ the different dimensions in their overall thinking about the world and self is measured. Therefore it is appropriate to measure how a user's overall world thinking compares to his/her overall self thinking. This has been done for decades and is reflected in the Attention Balance score. What this new art includes is applying in scoring adjustments how the user's extreme Attention Balance orientations affect the individual perspectives noted in the different profile scores and in the valuation scores.
An example of this is seen in positive self extrinsic thinking (value score of 8), where User A values other people in comparison to his/her self and User B values his/her self more than others. This would result in User A's confidence leading to industriousness and usefulness on behalf of others and User B's confidence leading to a focus on getting personal recognition and winning (even possibly at the expense of others with whom s/he works).

### 3. Scoring, Comparing and Evaluating the Effects of Valuations

Just as the value scores are measured, it is also valuable and important to measure the biases and clarities of the valuations. The axiological ranking of the profile test terms is affected significantly by the valuations, yet heretofore the valuations have been overlooked in the scoring algorithms. One can measure the relationships of the valuations (as the value relationships are measured) by changing the axiological rankings to be according to the valuations and then measuring the relationships of those biases and clarifies as those for values were measured. Clear Direction, Inc. has been measuring user's valuation scores since 2008 and have included descriptions of those scores in a number of their published reports.

The only relationships that the Clear Direction scorings measured and identified were when the individual dimension valuation score differed from the corresponding value score. This new art will include the following previously overlooked relationships:
how the components of each valuation relate to each other and create that valuation score,
how the valuations in the same frame of reference relate to and affect one another,
how the valuations interact with and affect the thinking in the other frame of reference, and
how the overall valuations of the two frames of reference affect the user's perspectives, in the individual parts, in relation to the values scores, and in relation to the user's whole perspective.
   4. Measuring the Ratios and Characteristics of the Compositions and Transpositions that Make up the Profile and Valuation Scores:

One thing that is missing from previous scoring methods is the measuring of the parts that make up the biases and clarities within each individual dimensional score and each individual valuation score. Each score is derived from how six statements with similar dimension characteristics compare with their corresponding axiological rankings. This is true for both values and valuations. Three of the statements are compositions and three are transpositions. It is valuable to identify differences, when they exist, between the values (or valuations) with compositions and the values (or valuations) with transpositions.
For example: As noted above, it is very helpful to measure the components of an intrinsic world score, say 8, because an 8 can be comprised of different relationships between the compositions and transpositions. One 8 could be composed of only positive compositions and only negative transpositions. Such a person does not see treating others with disrespect as bad while having a stronger bias toward treating them well. A different person with an 8 could have the opposite orientation: believing it is bad to treat others with disrespect while it's OK to not treat them kindly. These two possibilities may seem incongruous (because to components do actually disagree with each other) yet these kinds of relationship ‘disagreements’ exist in most of the people tested over the years. Measuring how the compositions and transpositions make up both the value and valuation dimensional scores can be very helpful and useful.
Secondly, for interpersonal and communications applications, it can be helpful to know how one user's intrinsic world score of 8 is different in its perspectives and outcomes from the same score of 8 for another participant. With differing combinations of compositions and transpositions, these two people will think about and conclude differently about being empathic or sympathetic toward others. Providing communications training, advice, tools and resources measuring these differences becomes crucial for those applications to be useful and effective.

### 5. Scoring and Noting How Profile Report Scores Affect One Another: the Ratio Score

While the general patterns created by the three profile report scores have been identified and described (and given descriptive titles), a mathematical scale for those combinations has not been previously developed.

For example: world scores of 5, 5, 7 create the same general pattern as 3, 3, 9, and would previously have been given the same descriptive title (‘a responsible perfectionist’) even though they are very different (the scores are logarithmic, so a 3 is very different in its degree of skepticism from a 5 and a 7 is very different from a 9). The measuring of the differences of scores within the same frames of reference is one of the new arts in this this application and is called a ratio score.

### 6. Measuring and Keeping Track of the Rare Thinking Relationships and Defining How They Are Important to the User

With the addition of the above noted scores many new relationships can be measured. This would not only require the software being written to do and record these comparisons, it would require that the software change the priorities of these findings as their frequencies change over time. Because this has not been done previously, the software would be written so the thousands of relationships could be measured, counted, and compiled so that rare combinations could be identified.
For example: in measuring the biases and clarities of compositions and transpositions, it may be found that a person has ‘perfect’ clarity in transpositions for all six dimension value scores. It could be very helpful for such a person to know why others don't see what is obvious to him/her. Secondly, it could be very helpful to that person and his/her family and friends to know why everything s/he says is pointing out how someone or something is ‘wrong’. The software will enable the machine to learn which sub-relationships, that are now measurable, would enable this identification and reporting.

### 7. Prioritizing the Most Significant Aspects of the User's Thinking

The first patent provided a priority list for reporting strengths and weaknesses solely based on the user's thinking of the values in relationship to the axiological rank and to the user's perspectives on those values. From these scores, an algorithm was written that prioritized those scores in relation to each other, essentially listing the individual scores that were either closest or farthest away from the axiological ranks. This invention processes and prioritizes from the first patent's database, along with the above mentioned valuations scores, composition and transposition scores, patterns which those elements form, and relationships of the scores to each other. From this greater database a richer, more accurate ranking of the user's thinking elements and tendencies can be delivered. Secondly, this invention identifies the patterns that correspond to one another and are most dramatic in relation to the user's other perspectives. This broadens the range of what is delivered, including the ability to deliver insights that otherwise were not possible. When one particular thinking orientation is dramatically far from the others, it causes more stress, anxiety or frustration for the user. With this prioritization these outliers will be identified, named, described and the user will be provided targeted training to address them to reduce any unwanted effects. Thirdly, this invention evaluates the user's scores in relation to previous and current users, with particular attention to rarity, and brings to the fore those scores that either represent significant strengths or likely liabilities. Machine learning will adjust the ranges and frequencies of rarity of all of the computed scores and relationships. Because the specific nature of the thinking is modeled by the defined elements and the scores, the meaning of the scores can be deduced into accurate and meaningful language and provide precise descriptions with targeted training and development now possible.

8. Software that Continually Analyzes and Updates the Records of Frequencies of Key Thinking Elements, Patterns, and Their Relationships

The user's thinking (key elements and key relationships) will be compared to those of the population of previous users. The software will continually update the records of the key scores and relationships by adding each user's scores to the database. Those scores will be factored into means, medians and/or extremes in order to provide accurate and useful information to each user. Additionally, the software will continually analyze the frequencies of the different scores and re-rank their importance in relation to each other by analyzing frequencies and ranges of scores. To the extent a user has a rare thinking orientation, it can be very helpful to know that and know how that orientation lies with reference to the general population. The standard deviations used to determine how much out of the norm will be determined by the software analytics.

9. Translating the Scores and Measured Relationships into Common, Useful Text, and Instructions for Tech Devices

Because each term is formally defined, the terms and their relationships are easily translated into meaningful text that describes what was measured. These descriptions will be held in text fields that are called up by the software for use in reports and by tech devices. The prioritization of what is called up will be based on all of the measured relationships of thinking elements to each other, to the axiological order, and to those of other users. Besides making short, easy-to-read reports possible, this objective prioritization will reduce the professional reviewers' biases from their reviews.

The following two charts present 4 of the above 9 elements as they correspond to the scoring of the Values and Valuations and apply to the Prioritization for Reviewing a Profile. The large numbers (1-5) on the charts correspond to the numbers assigned to the above descriptions of this invention.

### DETAILED DESCRIPTION OF THE INVENTION

### The User's Task

While the process of taking a profile is as reviewed in the first patent, with new hardware and software some physical differences exist. As previously, an individual logs onto the Internet website of the personal training and development delivery system, or an intranet of his firm or company, and takes the Kinsel-Hartman Profile. The individual will be required to self-identify in order to enter the site and complete the profile tasks, and this may be by typing, speaking, voice/eye/face recognition, etc. The individual's pertinent information is entered (whether e-mail address, phone number, or some other identifier) so that the requested report(s) and training/development reminder(s) can be sent directly to that user. The individual takes the Kinsel-Hartman Profile by moving statements into a list, by drag-and-drop, by voice, by eye movements, in a game format, with a virtual reality headset, or by holographic interaction.

The Kinsel-Hartman Profile is comprised of formal representations of the 18 value combinations, thus having the user compare all of the categories available. To rank these the user must decide what each statement (term) means and then compare those with one another. It is the axiological values for each of the statements that enable the mathematical ranking of the statements according to their intentions. These rankings (the ‘axiological rank’) are used as a guide to analyze the participant's rankings.

Once all of the tasks have been completed, the participant is informed where his/her report(s) will be electronically sent to him/her (by varying methodologies, including email, text, SMS, What's AP, Linked In, Facebook, etc.) or how and where the participant can retrieve his/her own results (webpage, portal, etc.). These results are sent automatically using commercially available electronic packages. The reports can vary from printed reports of approximately 60 pages segmented into four parts, to single pages with additional single page reports generated that build upon each other. The reports can also be administered to the user by Agents (Ski, Alexa, OK Google, etc.), or to the user's choice of electronic receivers (agent box, computer, phone, watch, ear buds, etc.). The different reports are designed for user-selected applications and differing levels of detail about the user's thinking.

### The Invention

The invention is software logic, algorithms, and newly developed and named scores that identify, measure, and direct the software to select what is reported in text (written or verbal) about the relationships of the elements of a person's value structure (the model of how a person values, derives meaning, prioritizes, and makes decisions). This invention introduces analysis of the compositions and transpositions that make up each individual profile score, scores for valuations that include the clarity and bias which affect the rankings of each of the value statements, the relationship of the value and valuation elements of the two frames of reference in relation to one another, and scores that represent how the overall thinking orientation affects individual value and valuation perspectives.

Additionally, this invention includes algorithms that direct the software to continually update the averages and standard deviations of the scores and relationships of each of the individual and relationship scores, keep those updates in a master database that includes the frequency of those scores, and analyzes each user's profile scores in light of the axiological rankings and identifies patterns indicating scores closest to the axiological ranks and farthest away from the axiological rank. From this analysis, the software will prioritize the information in an ordered list is for presentation to the user.

The new art of this invention made up of the following:

### The New Art

Regarding the Profile (Dimension) Scores:
   The Variances of the Scores for Each Frame of Reference
   Their Ratios to the Other Two Profile Scores
   Their Compositions and Transposition Makeups
      Individual Dimension Composition and Transposition Dims
      Individual Dimension Composition & Transposition Percentages
      The Ratio of the Positive Rankings to All of the Rankings
   The Specific Dimension Profile Scores in Relation to One Another
      Adjustments to Those Relationships Based on Attention Balances
      Adjustments to Comparison Scores Based on Rho Scores
   Adjustments to Profile Scores Based on Rho Scores
   Adjustments to Profile Scores Based on Attention Balances
Regarding the Valuation Scores:
   The Combination of the Clarity and Bias of Each Valuation
   The Variances
   The Ratios to the Other Two Variances
   Their Compositions and Transposition Makeups
      Individual Dimension Composition and Transposition Dims
      Individual Dimension Composition & Transposition Percentages
   The Frames of Reference Profile Scores in Relation to One Another
   Extreme Valuation Rhos and Appropriate Adjustments of Valuation Scores
   The Specific Dimension Valuation Scores in Relation to One Another
      The Effect on Valuation Scores within Same Frame of Reference
      The Effect on Valuation Scores Between Frames of Reference
Machine Compilation, Storing, Analyzing, and Updating Frequencies of Relationships
Identification of User's Rarest Scores, Scores Closest to Axiological Ranks, Scores Farthest From Axiological Ranks, and the Best Order for the Profile Review

### Profile Scores: The Variance of the Scores for Each Frame of Reference

In order to be able to assess the relationships of the different elements within a user's thinking and to be able to have software identify key patterns and measures in those relationships, the author needed to create the following new scores. These scores model relationships among scores and provide scales that identify characteristics, similarities and extremes in how the individual scores are situated in relationship to each other.

One score that immediately reveals how the participant's thinking biases and clarities compare with each other is the variance of the Clear Direction report scores for the world and the self thinking frames of reference. The variance of the scores shows how close the three scores are to each other. Because these report scores are the result of biases and clarities, the variance will present the proximity of both the biases and the clarities. When the biases are very different or when the clarities are very different the variance will be large. When both the biases and the clarities are ‘close’ to one another, then the variance will be low.

When the variance of the three world scores (or the three self scores) is greater than 0.8, the person's individual scores contain at least one score that is outside the range of reasonability (multiple studies by Clear Direction, Inc., ZeroRisk HR, and Workforce Interactive have measured that scores outside the 4-8 range consistently result in problematic behaviors in work contexts and/or relationships). Such a high variance is an indication of at least one score outside the reasonable range with other scores significantly different from that unreasonable score (it is this difference that Hartman's dim % will not identify). This pattern represents the thinking biases that provide the greatest drama for the participant (drama being both strengths in certain contexts and weaknesses in other contexts) because the person is using one type of thinking processor to think about things pertaining to a different dimension. This overuse of one aspect of thinking is like a person using a screwdriver to do the job of a hammer. Coupled to an inability to clearly see how his/her thinking is skewed, it makes it difficult for the user to see the relevance of feedback or counsel that consistently provides evidence of an error in thinking.
A high variance indicates the user is depending on and evaluating things of one dimension (say intrinsic) from a perspective or with a processor that is better equipped to process different properties (say extrinsic). This can lead to many different responses with none actually addressing the presenting issue. An all too common example of this erroneous thinking is when a husband thinks that buying his wife a gift will make her feel OK when she is sad about the loss of one of her parents.
At first blush, one may assert that Dr. Hartman's dim % score reveals the same comparison as the above described variance score. Because Dr. Hartman did not derive a way to couple the biases and clarities (dims) into a single descriptive score (the combination being a model of the resulting behaviors resulting from the combination of the these two aspects of the person's thinking), his/her dim % score (based on the capacities only) provides a measure of how much the thinking of the participant varies from the axiological rank but does not include how the dimensions compared to each other for the participant and does not include the bias of that person concerning that dimension of value.

### The Profile Scores: The Ratios to the Other Two Profile Scores

Another significant relationship is identified by comparing the differences of the three scores in relation to each other. Each of the three scores in the same frame of reference are compared to the other two. This relationship is called the ratio and has not been previously measured. Dr. Hartman computed a score that he titled “DIM”, which was the two lowest individual dim scores (how many places each of the corresponding six value statements were off of their axiological ranks) subtracted from the highest individual dim score. The DIM did not include the effects of bias and only compared the lower dims to the higher dim (measure of thinking clarity). These ratio scores are significantly more robust, because by computing the percentage of each individual profile report score with the sum of the three report scores, we are able to compare them taking into account both the clarities and the biases. This makes it possible to see how each of them compares in relation to the other two.

For the sake of ease I have titled these scores i/1, e/1, s/1 (world ratios) and i/2, e/2, and s/2 (self ratios). The letter is the dimension name (i for intrinsic, e for extrinsic, and s for systemic) and the denominator 1 representing the sum of the world thinking scores and 2 representing the sum of the self thinking scores.

The extremes of the ratio scale indicate which thinking biases are either overpowered by the other thinking orientations or are the ones demanding all of the attention.

### The Profile Scores: Made of Individual Dimension Composition and Transposition Dims

As stated above, each individual dimension profile score is the combination of the user's bias and clarity concerning that dimension in that frame of reference. A simple set of scores was needed to be able to identify the components of each of the profile report scores. While the compositions and transpositions were ‘counted’ to get that dimension's overall dim and bias scores, these two categories were not scored themselves.

This new set of scores makes it easy to identify and measure the components within a profile score (their clarities which identify precision and ease of use). While the profile scores are very telling, measuring how they differ in their makeup increases the precision and usefulness. These scores represent the different components of each profile score, thus enabling the software to be more precise in its reporting, advising, and designing of training and development targets.

Additionally, a couple of important considerations apply to compositions and transpositions. The first is how they compare to each other in terms of clarity (dims). The invention carries out such comparisons and records them for analysis. For example, when a user's compositions are not clear but their transpositions are all extremely clear, then that person will be hyper aware of transpositions in that frame of reference and will react emotionally when addressing (thinking about, responding to, evaluating) compositions. That person will see error like an eagle and will avoid compositions. Secondly, the positive compositions and transpositions are analyzed and compared with the negative compositions and transpositions. While those categories are based on bias, the clarities are being measured in this case. This comparison enables the software to determine if the user's overall makeup of their value scores is clear or foggy in the positive and negative categories. When a person's negative scores have high clarity and the positive scores have foggy thinking, that person will be good at assessing what causes harm but not clear or definitive when it comes to adding or building constructively.

### The Ratio of the Positive Rankings to All of the Rankings

The percentage of the positive rankings (the compositions and transpositions that have positive biases) in relation to all of the rankings indicates the overall positive orientation of the user's thinking. In order for this ratio to be high (ratio close to 1), the user would have had to rank the statements is extreme positive positions, indicating strong emotional favoring of those terms along with fairly clear, not too biased positioning of the negative terms. This would indicate the person is strongly positive/optimistic. The opposite type of rankings (ratio close to 0) would indicate the person to be strongly negative.

### The Profile Scores: Made of Individual Dimension Composition & Transposition Percentages

It is also valuable to know if the compositions and transpositions differ in bias. Additionally the bias of composition or transposition can differ from the user's overall bias for a particular profile score, resulting in very important (and often contradictory) aspects about that user's thinking. In the case when a person has opposite biases between the compositions and transpositions for the same dimensional score, then that person will be optimistic and attentive to the aspect that has the positive bias (in compositions then that person will be biased toward making things better and in transposition then that person will be biased toward not harming or reducing the value of things) and will be skeptical or negative about the aspect with the negative bias, in thinking about the same types of things!
For example: in the self frame of reference can be seen in the 12. If the person has a positive bias in the transposition statements, then that person thinks that it is good to not be mistreated. If the person has a positive bias in the compositions, then the person thinks that it is good for him/her to be treated well.
On the other hand, when a person has a negative bias toward compositions, then the person does not want to be singled out as being special or unique (or loved). And when that person has a negative bias in transpositions, then s/he thinks it's good when others are disrespectful, unloving, shaming, etc.
When these distinctions are very helpful is when a user has a positive bias in one aspect (compositions or transpositions) and a negative bias in the other. While not being rare, this leads to confusing and contradictory behaviors and beliefs within that person.

### The Specific Dimension Profile Scores in Relation to One Another

Here we are identifying how the user values a dimension in one frame of reference in comparison to that same dimension in the other frame of reference. These are the comparison scores. While the two frames of reference are not compared directly with each other in the profile tasks, each frame of reference's set of scores indicate how much of each of the dimensions is getting attention (use) within their own frame of reference. So it can be helpful to compare how much the user values things and other people in a particular dimension compared to how much that user values him/herself according to that same dimension.
When a person highly values intrinsic value in others and pays very little attention to his/her own intrinsic value, this has significant outcomes for that person, both personally and vocationally. This is also true for the extrinsic and systemic dimensions.

### Adjustments to Comparison Scores Based on Attention Balances

The user's overall Attention Balance affects the behavioral and thinking outcomes of these differences. When an AB (Attention Balance) score corresponds to the differences between the individual dimension scores, then that AB reinforces that difference between those frames of reference. When an AB score is opposite the difference between the individual scores, then that non-congruence reduces the difference between the two frames of reference.

### Adjustments to Comparison Scores Based on Rho Scores

A second adjustment is computed with the reliability scores, called Rho scores. Dr. Hartman developed these scores (one for world thinking and the other for self thinking) that provided a measure of reliability of the user's rankings. It is a combination of many computed scores based on a scale that indicated overall thinking consistency and judgment. Effectively, Rho scores above 0.9 (0-1 scale) have proven to be indicators of consistently sound judgment in the corresponding frame of reference. When the Rho score is below 0.7, then the test answers for that user are suspect, and, depending on the other Rho scores, the users may be encouraged to retake the test.

### Adjustments to Profile Scores Based on Rho Scores

The Rho scores are indications of the overall clarity (which affect the user's ease of thinking about things in that frame of reference) of the world and of the self frames of reference. A significant difference between these two scores indicates that the user will be significantly more reasonable when thinking about things in the frame of reference that has the higher score. The resulting behavior is that the positive and negative biases in the less clear frame of reference will be more extreme (more reacting than reasoning). So it is important to adjust the individual profile scores in that less clear frame of reference in order to accurately describe the resulting behaviors.

### Adjustments to Profile Scores Based on Attention Balances

As we see in the section immediately preceding this one, the scores at the ends of the AB scale (0.3 and 3) affect the degree of difference in the scores for the same dimension for the world and self. The same need for ‘adjustment’ applies when considering the meaning of any individual profile scores. When the AB is 0.3, then it is appropriate to add one point to each of the profile self scores to increase the strength of that thinking in the descriptions of those positive profile self scores.

In similar manner, when the AB score is 3, it is appropriate to add a point to each of the profile world scores to more accurately describe the characteristics of each of those world scores to the user.

### Scoring Valuations as We Scored Values

Valuations are the adjectives or actions upon the value, the noun. It is common for users to have positive orientations towards certain valuations while they have negative orientations toward the value of the same dimension. This new invention includes the scoring of valuations in the same manner as we score values, including assessing compositions and transpositions, comparing them between frames of reference, and comparing them with all other valuation scores.
A person can favor intrinsic world values and not favor intrinsic world valuations. These people will be inclined to show “love” to another person by “doing helpful, practical things” (extrinsic valuation), but not show any concern or interest in what the other person feels or cares about (intrinsic valuation).

It is helpful for the user to know when his/her valuation bias does not correspond to the value bias. In the cases where the valuation is negative and the value is positive, the person does not reveal clearly what s/he values. When the valuation is positive and the value is negative the person has underutilized potential. In either case, the user can reduce confusion and unwanted outcomes by knowing how to get his/her valuations and values to correspond to each other.

### Regarding the Valuation Scores: The Variances

The variances of the valuation scores is to valuations what the variances of the profile scores is to the values. So computation and analysis will be identical, except the subject is the six valuation scores instead of the six value scores.

### The Valuation Scores: The Ratios to the Other Two Variances

Again, the meaning, computation, and analysis of the ratios of the valuation scores will be as was for the value scores, except being applied to the valuations.

### Regarding the Valuation Scores: Their Composition and Transposition Makeups

Individual Dimension Composition and Transposition Dims

Again, the meaning, computation, and analysis of the composition and transposition dims of the valuation scores will be as was for the value scores, except being applied to the valuations.

### Regarding the Valuation Scores: Their Composition and Transposition Makeups

Individual Dimension Composition & Transposition Percentages

Again, the meaning, computation, and analysis of the composition and transposition biases (% positive) of the valuation scores will be as was for the value scores, except being applied to the valuations.

### Regarding the Valuation Scores: The Frames of Reference Profile Scores in Relation to One Another

Again, the meaning, computation, and analysis of how each valuation score compares to the corresponding valuation score in the other frame of reference will be as was for the value scores, except being applied to the valuations (valuation comparison scores). This includes the adjustments for extreme valuation Rhos, as were described for the values above.

Regarding the Valuation Scores: The Relationship of the Rhos to Each Other Again, the relationship of the valuation rhos to each other will be computed and analyzed as the comparison of the value rhos were above.

### The Specific Dimension Valuation Scores in Relation to One Another

The Effect on Valuation Scores within Same Frame of Reference

Again, how the valuation scores relate to and affect one another within the same frame of reference follows the same logic and computations as was followed for the values, except using valuation scores instead of value scores. These are the valuation ratios for the world and self frames of reference.

### Machine Compilation, Storing, Analyzing, and Updating Frequencies of Relationships

The programming of this technology will include a running recording and comparing of the computed results. The prioritization of which scores, patterns, and relationships to report will in part be based on rarity of those thinking orientations/abilities. In these cases, the algorithms for that prioritization will base the selection of what is reported on present time frequencies, which will be continually updated as more profiles are processed. Additionally, all of the updated scores will be compared so scores, patterns and relationships that become rarer or more significant will rise in their selection status. As the frequencies of different scores (representing different relationships within participants' value structures) will change and thus the software will adjust the scales of importance based on the most up to date data.

### Identification of User's Rarest Scores, Scores Closest to Axiological Ranks, and the Best Order for the Profile Information to Be Presented

The programming compares the user's scores to the scores determined by the software and identifies all scores that are rare to other scores determined by the software (in most cases it is anticipated that would be 3 or more standard deviations from the norm). The software will continually average all of the users' scores, determine what constitutes rarity, update the rare score ranges for each score, and record any changes in those scores.

The program will also measure rarity in regards to axiological ranks. It will determine what scores are rare based on closeness to axiological perfection. This will differ from the above rare scores, in that they may not meet the determined definition of ‘rare in relation to all other users’ but rather are ‘rare in relation to other scores’. Again, the software will analyze this for each user and record those findings in the user's data set.

With the above information in the user's data set, the software will now be able to prioritize the elements of the user's profile to design an order for profile review. One of the reasons for this invention was the need to have a list of the most significant elements of the user's thinking put in an ordered list. The software will follow this formal ordering:

The Order of Prioritization for Profile Reviews (*denotes new art required)

1. Scores exactly on the axiological rank.

2. Scores close to the axiological rank and rarity*.

3. Scores that are rare in comparison to other users*.

4. Significant patterns leading to strengths.

5. Elements and/or relationships that take command of all of the decisions*.

6. Significant patterns between/among scores*.

7. Significant outlier value, valuation*, types of reasoning, and balance scores.

8. General descriptions of each of the six value scores including any disagreements between valuations, compositions, transpositions and corresponding values*.

9. Description of the interactions* in the Frame of Reference with the higher Rho.

10. Description of the interactions* in the Frame of Reference with the lower Rho.

11. Relationships that can undo strengths and result in misperceptions.

### From Number Scores to Text

All of the dimensions of value and the terms in a value profile are formally defined. The relationships that are scored are logical interactions. So every score and relationship can be accurately described with words that correspond to the meanings of each of the scores and of the relationships.

The meanings and a sample of this procedure is:

### The Meaning of the Three Values in Two Frames of Reference

1A A person, love, passion, life, personal feelings

1B Real empirical things, social, material success, power, energy, “want to”

1C Logic, ideas, formal constructs, order, ‘shoulds’, principles, right/wrong

2A Myself, who I am, my inner being, my gestalt, my spiritual being, my life

2B What I do, how I appear, my initiative, confidence, body, how I compare

2C My principles, values, commitments, standards, goals, my self-definition

### The Meaning of the Two Valuations for the Three Dimensions of Value

| | |
|---|---|
| 1A Compositions | kind, attentive, caring, loving, empathizing, |
| | honoring |
| 1A Transpositions | hateful, demeaning, killing, annihilating |
| 1B Compositions | improving, making better, energetic, effective, |
| | useful |
| 1B Transpositions | disrespectful, physically harming, broken, |
| 1C Compositions | logical, reasonable, orderly, understandable, |
| | efficient, right |
| 1C Transpositions | disorderly, confusing, illogical, unreasonable, |
| | confusing |

The text that is generated by the invention will follow the logical application of the above meanings. In the following example, the text is followed by the scores in parentheses:

Bob's World Scores: 1A=8

1A VALUATION=3 with (COMPOSITION=7) & (TRANSPOSTION=3)

1B=4 with a 1B VALUATION=9

1C=8 with a 1C VALUATION=6

Text: “Bob,
You are naturally attentive to the value of individual persons meaning that you genuinely care for and about people on an individual basis. You'll do work by building personal relationships and care for your work and friends personally (1A=8). Your optimism toward others and things that you take personally has two aspects: The first is you believe it is good to treat others kindly and pay attention to what they care about (JA Composition of 7). The second aspect will seem contradictory in that you also don't think it's bad to have another person feel pain, be left to their own feelings, or not have their concerns be listened to (1A Transposition of 3).
Additionally, while you care on the inside about others and their concerns, you prefer to show your compassion by doing things for them, and not by spending time listening to their feelings or concerns (1B Valuation of 9 with the other two valuations being below 7).”

### Examples of Applications

In healthcare: equipping doctors and other healthcare providers to better communicate with their patients, in order to get more accurate information from the patients (the most common problem doctors report having is that their patients are not honest with them), more accurate ways to motivate and communicate expectations and instructions, and effective and technologically aided follow ups to increase the incidence of patient compliance and accuracy of taking prescribed medications.

In managing a business team: equipping the manager to more effectively communicate, direct, motivate, and assign tasks in light of that manager's own thinking and in light of each direct report's unique ways of thinking.

In building an effective team: providing the ability to assess the natural strengths and liabilities in a group of people that comprise a team. Different make ups are needed for teams to perform effectively at different tasks, within different markets, and under different conditions. Being able to evaluate what is needed (by using the categories of value science) a team head could quickly see if his/her team is comprised in a way that success is likely.

In providing constructive feedback: almost everyone is open to consider new ideas if they are approached in ways that fit their ways of thinking. This invention will provide a very precise roadmap that one could follow to increase the likelihood that feedback will be well received.

In psychology/therapy: being able to precisely identify the makeup of a person's low self-esteem, enabling the psychologist to target discussions and therapies that address the problem at the core, not at some general condition that may or may not respond to the therapist's remedies.

In coaching of athletes: distinguishing between general confidence, that causes an athlete to perform at higher levels when under pressure, and specific confidence that can cause an athlete to perform poorly under pressure.

In training and development: as the first patent outlined, the information from a value profile is very helpful in designing both an approach and a curriculum for training and development. This new invention, being significantly more robust and accurate, makes such training and development more precise and accurate.

Friendships, dating, marriage, parenting, and growing old: all benefit from the participants having accurate self-awareness. From not imposing one's own needs on the relationship, to being able to be engaged but not dependent, to being able to empathize and not sympathize, all the way to wanting to be in relationships while not needing to be in those relationships.

In career counseling and selection of a career track: The information gained from a value profile includes what motivates the user (and what demotivates that user), the kinds of interactions with others that are most enriching, the nature of the user's desire for practical outcomes at work, the importance of the mission of one's career or employer, and what secondary impediments could derail the user from his/her primary objectives.

In managing security personnel: Managers of police, security forces, and military forces would be able to identify potential problem personnel in their forces prior to significant problems occurring. Presently, such leaders are hesitant to dismiss or reassign personnel with one complaint for misconduct. The new art enables significant insight into the user's thinking, including thinking that supports prejudice, inability to function effectively under stress, and willingness and ability to follow orders when someone has broken the law.

### The Computing Logic of the New Invention

The following logic includes some scores that are part of the old art. These are listed because they are essential for the new art algorithms (noted by *). The following logic will be the same for the Self Frame of Reference (2) as is listed here for the world Frame of Reference (1).

KEY:

‘A’ stands for Intrinsic Value, ‘B’ for Extrinsic Value, ‘C’ for Systemic Value

‘a’ stands for intrinsic valuation, ‘b’ for extrinsic valuation and ‘c’ for systemic valuation

‘AR’ stands for Axological Rank

DIM stands for a clarity score (how close to the AR is that item or set of items).

Compositions are “Comp”

Transpositions are “Trans”

FoR=Frame of Reverence (1=world and 2=self)

Composition and Transposition Report SCORES

| | Negative | Cautious | Balanced | Attentive | Positive |
|---|---|---|---|---|---|
| Dim | | | 6 | | |
| Clear | | | 5 7 | | |
| Ok | | 3 4 | (mod) | 8 9 | |
| Poor | 1 | 2 | (low) | 10 | 11 |

COMPUTATIONS (* designates new art)

### Axiological Rank

AR: Computing each Axiological Rank is the same as noted in the first patent and described in the text above.

### *Ratio Scores

Ratio scores are each of the profile scores in a Frame of Reference in relationship to the sum of the other two.
   To compute a ratio score make the designated score the numerator and the sum of the other two profile report scores the denominator. Express this score in ratio form.

### *Variances

The Variance scores are a number that indicates how close the three profile report scores are to one another. The computation is +Var(1RPTA+1RPTB+1RPTC)=1VAR
and +Var(2RPTA+2RPTB+2RPTC)=2VAR

### * Comparison Scores

Comparison scores are the result of comparing the same dimension scores in the two FoR. The math is to subtract each of the Self profile scores from their counterpart World profile Scores (1RPTA−2RPTA=ComparisonA). The result will be three scores: ComparisonA, Comparison B, and Comparison C. Before these comparisons are computed, the following adjustments must be made.
Adjustment 1: when the AB score is 0.3, then reduce the world profile scores by one point for the Comparison computation.
Adjustment 2: When the AB score=3, then reduce the self profile scores by one point for the Comparison computation.
Adjustment 3: When the absolute value(s) of two or three of the above computed comparison scores >3, and one dimension has a profile score >5, with the other two dimensions' profile scores in that same frame of reference are <6, then add 0.5 to the absolute value of that positive profile dimension score.
Example: Assume the following scores (A, B, C):
World Profile Scores: 8, 7, 3 Self Profile Scores: 3, 5, 8
   According to the above logic we would add 0.5 to the systemic self score (from 8 to 8.5) because the other two self scores (A=3 and B=5) are negative, thus reinforcing the positive ‘C’ score of 8.
   The world intrinsic of 8 is not reinforced because the extrinsic world score of 7 is also positive, thus getting some of the attention (energy, optimism, etc.) and it is sharing the reinforcement provided by the negative systemic world score of 3.

### * Computing the Ratios of the Comparison Scores

Add the two intrinsic adjusted comparison scores to each other and divide that number into the adjusted world intrinsic comparison score.

1RPTA/(1RPTA+2RPTA)=ComparisonRatA

Do the same for the extrinsic and systemic scores.
The three sets (A, B, and C) are called ComparisonRatA, CompariosnRatB, and ComparisonRatC.

### Computing Compositions

Computing DIM (clarity) for Compositions (compositions are a (=i), b (=e), and c (=s))
Add the absolute value of each of the three |AR A|+|AR A|+|AR A|=CompDImA.
   (may be something like |4|+|−5|+|−3|=12=CompDIMA)
Do the same for B and C: Giving you CompDIMB and CompDIMC respectively.

### Computing Composition Valences (CompValA, CompValB, CompValC)

Add the positives values of AR Aa, AR Ab, and AR Ac and the divide that sum by the CompDIMA. This will give us CompValA. Put that answer in the form of a percentage
   (ex: if the three noted ARs are 2, 0, −1 then we have a total of positives of =2
   and with a CompDIMA=3, the CompValA=67%)
   For CompValB, add the positives values of AR Ba, AR Bb, and AR Bc and then divide that sum by the CompDIMB. This will give us CompValB.
      Put that answer in the form of a percentage
   For CompValC add the positives values of AR Ca, AR Cb, and AR Cc and then divide that sum by the CompDIMC. This will give us CompValC.

### Computing Composition Report Scores (CompRpt) for A, B and C

| CompDIM_ | − | 0 | + |
|---|---|---|---|
| Clear <4 dim | <34% (5) | 34-66% (6) | >66% (7) |
| OK dim 4-6 | <37% (3) | 37-49.99 (4) | >63% (9) |
| | | 50-63%(8) | |
| Poor >6 dim | <40% (1) | 40-49.99 (2) | >60% (11) |
| | | 50-60%(10) | |

TO GET CompRPTA score (do the same for B and C):

```
  IF the CompDIMA =0 then COMPValA=.5 (50%) and go to END, otherwise go
to next step
  If CompDimA>6 and CompVALA>60%, then CompRPTA=11, otherwise go to
next step
  If CompDIMA>6 and CompVALA>=50%, then CompRPTA=10, otherwise go to
next step
  If CompDIMA>6 and CompVALA>=40%, then CompRPTA=2, otherwise go to
next step
  If CompDIMA>6 and CompVALA<40%, then CompRPTA=1, otherwise go to
next step
  If CompDIMA>=4 and CompVALA>63%, then CompRPTA=9, otherwise go to
next step
  If CompDIMA>=4 and CompVALA>=50%, then CompRPTA=8, otherwise go to
next step
  If CompDIMA>=4 and CompVALA>=37%, then CompRPTA=4, otherwise go to
next step
  If CompDIMA>=4 and CompVALA<37%, then CompRPTA=3, otherwise go to
next step
  If CompDIMA<4 and CompVALA>66%, then CompRPTA=7, otherwise go to
next step
  If CompDIMA<4 and CompVALA>=34%, then CompRPTA=6, otherwise go to
next step
  If CompDIMA<4 and CompVALA<34%, then CompRPTA=5, end RPT
calculations
  END
```

### Example: if CompDIMA=5 and CompVALA=60%, then the CompRPTA=8

### Computing Transpositions

Computing DIM (clarity) for transpositions (transpositions are x(=s), y(=e), z(=i))
Add the absolute value of each of the three AR Ax, AR Ay, and AR Az. This gives you TransDimA. (may be something like |11|+|8|+|−3|=22=TransDimA
Do the same for B and C: Giving you TransDimB and TransDimC respectively.

### Computing Transpositions Valences (TransValA, TransValB, TransValC)

Add the positives values of AR Az, AR Ay, and AR Ax and then divide that sum by the TransDIMA. This will give TransValA. Put that answer in the form of a percentage
   (ex: if the three noted ARs are 4,3,−5 then we have a total of =7 (with a TransDIMA=12) So the TransValA=58.3%
TransValB: Add the positives values of AR Bz, AR By, and AR Bx and the divide
   that sum by the TransDIMB. This will give us TransValB.
      Put that answer in the form of a percentage
TransValC: Add the positives values of AR Cz, AR Cy, and AR Cx and the divide that sum by the TransDIMC. This will give us TransValC.
   Put that answer in the form of a percentage

### Transposition Report Scores (TransRpt)

| World Frame of Reference: | Below 4 | 6 | (5-7) | Above 7 |
|---|---|---|---|---|
| Intrinsic | 3.3% | 13.0% | (56.2%) | 26% |
| Extrinsic | 8.6% | 4.3% | (26.1%) | 17.3% |
| Systemic | .65% | 1.1% | (12.8%) | 84.3% |

TO GET TransRPTA scores: (follow same logic for B and C):
If the TransDIMA=0 then TRANSVa1A=0.5 (50%) and go to END, or go to next
If TransDimA>6 and TransVALA>60%, then TransRPTA=11, or go to next
If TransDIMA>6 and TransVALA>=50%, then TransRPTA=10, or go to next
If TransDIMA>6 and TransVALA>=40%, then TransRPTA=2, or go to next
If TransDIMA>6 and TransVALA<40%, then TransRPTA=1, or go to next
If TransDIMA>=4 and TransVALA>63%, then TransRPTA=9, or go to next
If TransDIMA>=4 and TransVALA>=50%, then TransRPTA=8, or go to next
If TransDIMA>=4 and TransVALA>=37%, then TransRPTA=4, or go to next
If TransDIMA>=4 and TransVALA<37%, then TransRPTA=3, or go to next
If TransDIMA<4 and TransVALA>66%, then TransRPTA=7, or go to next
If TransDIMA<4 and TransVALA>=34%, then TransRPTA=6, or go to next
If TransDIMA<4 and TransVALA<34%, then TransRPTA=5, end RPT calculations. END

### Example: if TransDIMA=5 and TransVALA=60%, then the TransRPTA=8

### Computing DIM_(A, B, and C),

DIM is the overall clarity score for each dimension of value. This is one of the key scores used to compute the profile score. Do the same for A, B and C.
Add the CompDIMA and TransDIMA=DIM A

### * Computing the Ratio for Compositions CT % (A, B, and C),

CT % is the percent positive the compositions are in relation to the total DIM for each dimension.

Divide the CompDIMA by the sum of CompDIMA and TransDIMA=CT % A

Divide the CompDIMB by the sum of CompDIMB and TransDIMB=CT % B

Divide the CompDIMC by the sum of CompDIMC and TransDIMC=CT % C

### Computing Valences (VAL) for A, B and C

The computing of Valences for each dimension within a Frame of Reference was outlined in the first Patent (These are called VAL A, VAL B, and VAL C) and is described in the text above.

### Computing INTs

To Compute INT A: Take each of the six AR A_s (AR Aa, AR Ab, AR Ac, AR Az, AR Ay, AR Ax.) and subtract 2 from the absolute value of each. Then sum those six results that are above 0 and ignore all below 0. This gives you INT A.

Do the same for the six AR Bs to compute INT B and the AR Cs to get INT C

### Computing Report Scores (RPT_) for A, B and C

| Self Frame of Reference: | Below 4 | 6 | (5-7) | Above 7 |
|---|---|---|---|---|
| Intrinsic | 17.3% | 3.5% | (28.1%) | 3.5% |
| Extrinsic | 16.2% | 3.4% | (16.2%) | 34.2% |
| Systemic | ,06% | 2.8% | (13.0%) | 71.4% |

Computing the RPTA, RPTB, and RPTC scores:
To Compute the RPTA score:
If DIM=0 then VALA=0.5 (50%) and go to END, otherwise go to next step
If DIM A>12 and VAL A>60%, then RPTA=11, otherwise go to next step
If DIM A>12 and VAL A>=50%, then RPTA=10, otherwise go to next step
If DIM A>12 and VAL A>=40%, then RPTA=2, otherwise go to next step
If DIM A>12 and VAL A<40%, then RPTA=1, otherwise go to next step
If DIM A>=7 and VAL A>63%, then RPTA=9, otherwise go to next step
If DIM A>=7 and VAL A>=50%, then RPTA=8, otherwise go to next step
If DIM A>=7 and VAL A>=37%, then RPTA=4, otherwise go to next step
If DIM A>=7 and VAL A<37%, then RPTA=3, otherwise go to next step
If DIM A<7 and VAL A>66%, then RPTA=7, otherwise go to next step
If DIM A<7 and VAL A>=34%, then RPTA=6, otherwise go to next step
If DIM A<7 and VAL A<34%, then RPTA=5, end RPT calculations
END

### Example: if DIM A=8 and VAL A=50%, then the RPTA=8

* ADJUSTMENTS OF RPT scores:

The RPT A, RPT B and RPT C scores can be adjusted based on other scores on that test and on scores from two test compared to each other. These adjustments are appropriate because other aspects of the user's thinking affect usage. Here are adjustments that must be made based on scores from the same test:
Adjustment #1—define high variance—valuation moves bias to positive
For RPT_, if the score is 1, 2, 3 and the variance is high and the valuation is >59% positive, then adjust the RPT_score to 9
For RPT_, If the score is 4 and the variance is high and the valuation is >59%+, then adjust the RPT_score to 8
Adjustment #2—reinforced by other two scores in same FoR
If two RPT_are <5 and the third RPT_score is >6, then add 1 to that higher RPT_score.
Adjustment #3—two positive scores reduce negative one in same FoR
If two RPT_are >7 and the third RPT_score is <3, then make the low RPT=1. If one dimension is very unclear compared to the other two and it is negative (esp. more negative than the other two)—it's a big deal
Adjustment #4—extreme Attention Balance Score(s):
   If AB=0.3 then the world profile report scores are reduced by 1
      If AB=3 then the self profile report scores are reduced by 1

### Computing_DIF

Add the 1DIM A and 1DIM B and 1DIM C to get the 1DIF (Overall clarity for World FoR)
Add the 2DIM A and 2DIM B and 2DIM C to get the 2DIF
   Computing VARINT1 (variance of INTs)
VARINT1 is the variance of INT A and INT B and INT C. This tell how close the three scores are to each other (the square of the differences to the mean).
   VARINT1=+Var(INT A+INT B+INT C)

### Computing TOR Scores

(TORA+, TORA−, TORB+, TORB−, TORC+, TORC−, 1TOR, 2TOR) When any value ending in a, b, or c (for example Bc) is given a ranking position above 9^{th} place, then one number is added to the negative dimension TOR (TOR_) for that letter dimension (so you′d add one to the total of TORB−). When a value ending in z, y, x (like Az) is given a ranking position below 10, then one is added to the total of the positive dimension TOR (TOR+) for that letter dimension (TORA+).
   Example: Bc is ranked 11^{th} and Cx is ranked 7,
   then one point gets added to TORB-=1 (because Bc was ranked above 9)
   and one point gets added to TORC+=1 (because Cx was ranked below 10)
TOR=|TORA+|+|TORA−|+|TORB+|++|TORC+|+|TORCH−|

### Valuations

(Axiologists in Sweden call these PERCEPTS, so we use ‘PER’ to identify these)
Compute the valuations scores in the same manner that the value scores were computed. The difference is the participant's ranking as scored according to the exponents (valuations) not the nouns (values). To compute the valuation scores (the exponents of the value combinations in the Tasks), treat those categories (I, E, S for world and self) in the same manner that the value scores were treated to gain the profile scores. This will result in six valuation report scores, one for each dimension in the world and in the self frames of reference.
   The Valuation Scores will be titled as the Value Scores were titled, except PER will be begin each name. PERDIMa, PERVALa, PERRPTA, etc.

### * Computing the Composition and Transposition Scores for the Valuations:

The composition and transposition scores for the valuations (PER) will be done exactly as they were for the values, just using the Axiological Rankings for the valuations instead of the ones for the values.
The ratio scores of the valuations will be computed.
The comparison scores and ratios of the valuations will be computed.
The variance of the valuations will be computed.

### Computing RHO

Take the sum of the squares of each of the AR scores, multiply that sum by 6 and divide that product by 5814 and then subtract that result from 1.
(5814 is n((n*n)−1) where n=number of items in test (18))
Example: the eighteen AR scores are 1,3,−4,−1,6,3,2,0,0,3,1,1,5,3,2,1,2,3
   The sum of the squares of those:
   1+9+16+1+36+3+2+0+0+9+1+1+25+9+4+1+4+9=131
      ((131*6)/5814)−1=0.86 so RHO=0.86

### Computing the Attention Balance

Computation for the Attention Balance (AB) scores are found in the first Patent.

### * Computing Total Composition and Total Transposition Clarity Scores

For the same field of reference, add the three dim scores computed for the compositions and the three dim scores for the transpositions. This gives the total clarity for the Compositions and transpositions for world and self. For example:
   1 CompDimA+1 CompDimB+1 CompDimC=1 CompDIM

### *Comparing Valuation and Value Report Scores to Determine Highest and Lowest

Comparing all of the profile report scores and the valuation report scores identifies whether one thinking orientation is dominant or essentially non-existent (in relation to the others). If one of the six scores is 2 greater than all of the others, it is a dominant way of thinking. The six scores being compared are: 1RPTA, 1RPTB, 1PRTC, 2RPTA, 2RPTB, 2RPTC. It is called 12HIGHRPTSCR.
In similar manner, when one of the six scores is two or more points lower than all of the other scores, record the score. It is called 12LOWRPTSCR.

### *Comparing Transposition and Composition Value Scores

Logic: when one of the twelve scores is two or more points higher than any other score, then that aspect of the user's thinking will be dominant. Record this score in the scoring data base.
Compare the following twelve scores: 1COMPRPTA, 1COMPRPTB, 1COMPRPTC, 2COMPRPTA, 2COMPRPTB, 2COMPRPTC, 1TRANSRPTA, 1TRANSRPTB, 1TRANSRPTC, 2TRANSRPTA, 2TRANSRPTB, 2TRANSRPTC.
If one of the scores is 2 or more points higher than the other eleven, then that is the dominant thinking. It is called 12HIGHCOMPTRANS.
   If one of the sums is 2 or more points lower than the other eleven, then that is the ineffective thinking. 12LOWCOMPTRANS.

### *Comparing Transposition and Composition Valuation Scores

Logic: when one of the twelve valuation scores for the compositions and transpositions is two or more points higher than any other score, then that aspect of the user's thinking will be dominant. Record this score in the scoring data base.

Compare the following twelve scores: 1PERCOMPRPTA, 1PERCOMPRPTB, 1PERCOMPRPTC, 2PERCOMPRPTA, 2PERCOMPRPTB, 2PERCOMPRPTC, 1PERTRANSRPTA, 1PERTRANSRPTB, 1PERTRANSRPTC, 2PERTRANSRPTA, 2PERTRANSRPTB, 2PERTRANSRPTC.
If one of the scores is 2 or more points higher than the other eleven, then that is the dominant thinking. It is called 12PERHIGHCOMPTRANS.
If one of the sums is 2 or more points lower than the other eleven, then that is the ineffective thinking. It is called 12PERLOWCOMPTRANS.

### *Computing Balanced Self Optimism

It is very rare (approximately 0.2%) that a person's self scores are very similar and all positive (above 5). This set of scores indicates that the user is optimistic about all three dimensions of him/herself (who s/he is as an individual person, what s/he is empirically, and how s/he should be). It also indicates that the clarities are very similar (noted by taking the variance of the three). When clarities are similar there is little anxiety or frustration because the experience of thinking about things in all three dimension's thinking is equally easy and clear, resulting in little frustration when required to switch from one kind of thinking to another type of thinking.
If the self variance is <1.5 and all of the self scores are above 5 then present this balanced self optimism. This score is called 2BSO.

### *Balanced World Optimism

This set of World scores is found in 11.5% of the population and is therefore significant. This set of scores indicates that the user is optimistic about all three dimensions of the world and other people. Unlike most who have at least one skeptical or negative orientation when thinking about things outside themselves, this person naturally values all three dimensions. This score also indicates that the clarities are very similar (noted by taking the variance of the three). As stated above, when clarities are similar there is little anxiety or frustration because each dimension's thinking is equally clear, resulting in little frustration when required to switch from one type of thinking to another.
If the world variance is <1.5 and all of the world scores are above 5 then present this balanced world optimism. This score is called 1BWO.
   *Computing World Skepticism (fewer than 0.01%):

This rare thinking orientation is when the user has a balanced but moderate to strong negative orientation about all three dimensions when thinking about others and the world outside him/herself. The balance is in the clarity, which are not high (unclear). The negativity is reflected in the three biases. The balanced clarity gives the person a sense of calm or OKness about what s/he is seeing, while in fact all the person is seeing is negative. This gives the user a sense that things are OK, even if the world is broken, disordered or people have bad intentions or behaviors.

1RPTA<6 and 1RPTB<6 and 1RPTC<6 and 1VAR<34% then 1BalSkep=1, otherwise 0.

*Computing a Sense of OKness with a Skeptical Orientation
If the world variance is <1.5 and all of the world scores are below 5:
1VAR<1.5 and 1RPTA<5 and 1RPTB<5 and 1RPTC<5 then 1SKP
   *Computing a the Sense of Self OKness with a negative self orientation (2SKP)
If the self variance is <1.5 and all of the self scores are below 5.
2VAR<1.5 and 2RPTA<5 and 2RPTB<5 and 2RPTC<5 then 2SKP

### Noteworthy Relationships

### Identifying Unique Scores and Relationships

All profile reviews since the 1960s have focused on extreme individual dimension scores (super low and super high biases and clarities). In order to not repeat scores that were identified based on high variances, the following cases must be considered. Such cases are when the variance is not high but an individual dimensional score is below 4 or above 8.

Additionally, when a user has two such scores (one in world and the other in self frames of reference), the more significant is the positive one when both of the other two scores are negative (below 6) in bias. Negative biases ‘reinforce’ positive biases (positive biases are an indication the user is using that thinking even when considering things with the properties contained in the dimension of the negative bias). So when two dimension scores are negative and the third score is positive, thinking in that positive dimension is ‘reinforced’ by the absence of thinking about both of the other dimensions. And when the positive biased thinking is unclear, it is what that user will rely upon without being willing/able to consider other choices, perspectives, or inputs (unclear thinking means that person is not able to integrate or see how new ideas or data apply).

Scores that are or are very close to being axiologically perfect:
Any individual dimensional DIM=0 or 1
Total DIM for either FoR=0 or 1
Composition dimensional DIM=0
Transposition dimensional DIM=0
Compositions in same dimension in both FoR=0
Transpositions in same dimension in both For=0
INT for all 3 dimensions in the same FoR=0

### Presenting Extreme Attention Balances

When the AB=0.3, the person is inner-directed. This is a measurement of the user's overall self thinking being significantly more clear and balanced than his/her world thinking. This is found in 7.4% of the general business population (and found in significantly higher percentages in competitive fields where users thrive on individual performance and high levels of persistence and focused determination: professional sports, the arts, chefs, sales, etc.).
When the AB=0.3
   When the AB=3, the person is outer-directed. Again, this is a measurement of the user's overall world thinking being significantly more clear and balanced than his/her self thinking. This is found in 9.7% of the general business population. It increases the person's sensitivity to others' perspectives and interests, often making it difficult for the user to use self thinking perspectives that have scores below 6.
When the AB=3
   Two profile scores <6 and the other >6 in the same FoR
For scores that have not yet been identified by the preceding procedures, those scores that have a ratio score that is <0.24 or >=0.5 are significant in relation to the other two scores. A score below 0.24 is only derived when that score is less than a quarter of the entire sum. This means that dimension score is very low in relation to at least one of the other dimension scores or is the lowest (in both cases the sum of the other two comprise more than ¾ths of the total). This means that the thinking with the score below 0.24 is not being used in relation to what was presented in the profile tasks. In the case of a ratio score being >=0.5, the dimension with that high of a ratio is commanding more attention than either of the other two scores (that make up no more than 50% of the total) and therefore is being used (depended upon) inappropriately to process and evaluate things in other dimensions.

### *1Rho−2Rho>1.81

The Rho is a score that reflects all of the scores in a particular Frame of Reference. Essentially it is an indication of overall ability to exercise judgment on a consistent basis. The scale is 0-1, with above 0.9 being very good and above 0.94 being excellent. When the two Rho scores differ by more than 0.8, then the user experiences significant capability, and ease of thinking in the higher FoR and struggles to make consistently sound judgments about things pertaining to the FoR that has the lower Rho.

*Big difference in the Biases of Composition and the Transposition
When the biases for the compositions and transposition differ and there is some scale of difference between the two:
   When C I1%>0.49 and T I1<0.5 and C I1−T I1>|3| then File that as C_T I1C
   When T I1%>0.49 and C I1%<0.5 and C I1−T I1>|3| then File that as C_T I1T.
   If neither of these are true, then file C_T I10
   Now repeat these steps for the other five dimensions to secure:
   C_T E1?, C_T S1?, C_T I2?, C_T E2?, and C_T S2?

### *Noting Extremely High Composition and Transposition Clarity Scores

1CompDIM, 1TransDIM, 2CompDIM, and 2TransDIM
Report when any of the above are=0 (exceptional ability to see constructive (comp) or error (trans)).
Report when any of the above=1 (very high ability to see constructive (comp) or error (trans)).

### Striking Individual Scores

These kinds of percentages will be computed and stored by the software. To begin the process, the following percentages of a random sample of 2,312 users in US businesses in the first decade of 2000 will be used for the three dimensions in two frames of references.
While all dimension scores of 6 are noteworthy, five of the six are very significant (ranging from 1.1% to 4.3% of the population) for they are rare and represent thinking about things in that dimension with a balanced bias and supremely clear ability to see and value things with these dimensional properties. These individual scores are to be highlighted without regard as to whether they have been discussed in prior sections because their rarity makes their users' experiences unique and oftentimes out of step with the majority of people with whom they interact.

### Balanced Self and World Thinking

Super clear and balanced thinking in the three dimensions for both of the frames of reference results in consistently high levels of judgment, senses of calm, and optimism. Because it is unusual (appearing in 2.1% of the US business population for world thinking and 2.3%, for self thinking, and 0.35% for both world and self thinking) it warrants special highlighting. This level of balance and judgment is demonstrated by all three dimension scores being in the very high clarity range (5, 6, or 7) in both the world and the self thinkings.
Balanced World Thinking=If all three world profile scores are >4 and <8,
Balanced Self Thinking=If all three self profile scores are >4 and <8,
Balanced W/S Thinking=If all six profile scores are >4 and <8,

### Percent Positive Scores of the Compositions and Transpositions: C I1%, T I1%, CI2%, TI2%, etc.

Take the total number of the individual positive dim points for the compositions of I1 and divide that by the corresponding C I1 score for that dimension. This will give the % positive for compositions for that dimension in that frame of reference. These percentages will be titled C I1%, T I1%, etc. Then repeat the same for e1, s1, i2, e2, and s2.

### *Computing Extreme Differences Among the Composition and Transposition Clarities, Biases, and Dimension Scores (for Values and Valuations)

In order to determine these, a few scores need to be created. First is the ratio of the composition score to the transposition score. Merely having a difference between these two determining significance is not an accurate measure (the total dim could be lower than the set score, so even with significant disparity that would not be identified). So
*Dim Ratio is the sum of the dims of the same dimensions in the two Frames of Reference over the sums of the dims of the other two dimensions in the two Frames of Reference. This is computed for 1i+2i, 1e+2e, and 1s+2s. A ratio <30% indicates good clarity in that dimension, while a ratio >85% indicates poor clarity in that dimension.
*Score Ratio is the sum of the scores of the same dimensions in the two Frames of Reference over the sums of the scores of the other two dimensions in the two Frames of Reference. Again, this will be done for all three dimensions. A ratio above 84% indicates that dimension is the master over the other two. A ratio is below 30% indicates that dimension is ignored by the user in relation to the other dimensions of value.
*PerDim Ratio is the sum of the dims of the valuations of the same dimensions in the two Frames of Reference over the sums of the valuations of the dims of the other two dimensions in the two Frames of Reference. This is computed for the valuations of 1i+2i, 1e+2e, and 1s+2s. A ratio <30% indicates good clarity when that valuation (I, e, or s) is applied, while a ratio >94% indicates poor clarity when that valuation of that dimension of value is applied. This will be done for all three valuations of the same dimensions of value.
*PerScore Ratio is the sum of the scores of the valuations of the same dimensions in the two Frames of Reference over the sums of the scores of the valuations of the other two dimensions in the two Frames of Reference. A ratio above 90% indicates that valuations of that dimension of value are the master over the other two. A ratio is below 30% indicates that valuations of that dimension of value are ignored by the user in relation to the other kinds of valuations.
Dif1/Dif2Ratio is the ratio between the three world dims added together over the three self dims added together. When this score is <0.3 or >200, it indicates significance (again, these ranges will be adjusted as the software computed running averages and standard deviations).
*CompTransDimRatio is the sum of the dims of the compositions in one Frame of Reference over the sums of the dims of the transpositions of the same Frame of Reference. When this score is greater than 199%, the transpositions are significantly clearer and when >50%, the compositions are significantly clearer.
*PerCompTransDimRatio is the sum of the dims of the compositions of valuations in one Frame of Reference over the sums of the dims of the transpositions of valuations of the same Frame of Reference. When this score is greater than 199%, the transposition valuations are significantly clearer and when >50%, the composition valuations are significantly clearer.

### *Computing the Percentage Positive Rankings (for Values)

The ratio of the positive placements in relation to all of the placements (differences from axiological ranking=dims for that dimension) can disclose three things. This ratio is significant when it is below 33% or above 66%.
   1) if the person's clarity is extremely clear or reacting for the positive or negative actions upon that value.
   2) which, if either, of the compositions or transpositions is neutral or strongly biased.
   3) if the biases of compositions or transpositions are contrary to the user's overall thinking about things of that value dimension.
This is computed by adding the positive composition dims and the positive transposition dims and dividing that sum by the total dims for that dimension.

### *Important Comparison Ratios

When any of these ComparisonRatA, ComparisonRatB, and/or ComparisonRatC ratio is >66% then report the overall strength of that dimension. When the dimension's ratio is <34% then report that overall ignoring/inattention (immaturity) regarding things in that dimension.
   *Noting a Sense of OKness with a skeptical orientation (1SKP)
   Another rare thinking orientation is when the user has a balanced but moderate to strong negative orientation about all three dimensions when thinking about him/her self. Again, the balance is in the clarity, which is not high (unclear) and the negativity is reflected in the biases. The balanced clarity gives the person a sense of calm or OKness about him/herself, while seeing negative about themselves. This is a general feeling of acceptance of how s/he is not useful, unclear about future direction and commitments, and not worthy of being loved or singled out.
   *Noting a the Sense of Self OKness with a negative self orientation (2SKP)
This combination is found in 2.2% of population. It is having a balanced sense of thinking, while the three value elements are all negative.
If the self variance is <1.5 and all of the self scores are below 5 then present this.

### *Important Comparison Scores

With all adjustments made, subtract each of the individual self dimension scores from the corresponding individual world dimension scores. When the difference is >3 then note that the world orientation toward that dimension of value is significantly more positive than the corresponding self orientation toward that same dimension of value. When the difference is <−3, then record that difference as the self score being a lot more positive than the world thinking about that dimension of value.
   Computing Running Averages* of Defined Elements in Relationship with Each Other

### Two Elements Joining Together (Values Agreeing):

1. IF 1RPTB>5 AND 2RPTB>6 then (1+TOTALVAGR1=TOTALVAGR1), Go to 2
   Then TOTALVAGR1/TotalUSERS=PercentVAGR1.
   Then print VAGR1 with PercentVAGR1 in text
2. IF 1RPTB>5 AND 1RPTC>6 then (1+TOTALVAGR2=TOTALVAGR2), Go to 3
   Then TOTALVAGR2/TotalUSERS=PercentVAGR2.
   Then print VAGR2 with PercentVAGR2 in text
3. IF 1RPTB>5 AND 2RPTC>6 then (1+TOTALVAGR3=TOTALVAGR3), Go to 4
   Then TOTALVAGR3/TotalUSERS=PercentVAGR3.
   Then print VAGR3 with PercentVAGR3 in text
4. IF 1RPTA>6 AND 1RPTB>5, then (1+TOTALVAGR4=TOTALVAGR4), Go to 5
   TOTALVAGR4/TotalUSERS=PercentVAGR4.
   Then print VAGR4 with PercentVAGR4 in text
5. IF 1RPTA>6 AND 2RPTB>6 then (1+TOTALVAGR5=TOTALVAGR5), Go to 6
   TOTALVAGR5/TotalUSERS=PercentVAGR5.
   Then print VAGR5 with PercentVAGR5 in text
6. IF 1RPTA>6 AND I2>5 then (1+TOTALVAGR6=TOTALVAGR6), Go to 7
   TOTALVAGR6/TotalUSERS=PercentVAGR6.
   Then print VAGR6 with PercentVAGR6 in text
7. IF 1RPTA>6 AND 1RPTC>7 then (1+TOTALVAGR7=TOTALVAGR7), Go to 8
   TOTALVAGR7/TotalUSERS=PercentVAGR7.
   Then print VAGR7 with PercentVAGR7 in text
8. IF 1RPTA>6 AND 2RPTC>6 then (1+TOTALVAGR8=TOTALVAGR4), Go to 9
   TOTALVAGR8/TotalUSERS=PercentVAGR8.
   Then print VAGR8 with PercentVAGR8 in text
9. IF 1RPTC>6 AND 2RPTB>6 then (1+TOTALVAGR9=TOTALVAGR9), Go to 10
   TOTALVAGR9/TotalUSERS=PercentVAGR9.
   Then print VAGR9 with PercentVAGR9 in text
10. IF 1RPTC>6 AND 2RPTC>6 then (1+TOTALVAGR10=TOTALVAGR10), Go to
11. TOTALVAGR10/TotalUSERS=PercentVAGR10.
   Then print VAGR10 with PercentVAGR10 in text

### Relationships That Can Be Strengths

11. If (2RPTB=6 Or 2RPTB=7) then (1+TOTAL sec2_10 SM=TOTAL sec2_10 SM), Go to 12.
   TOTAL sect 10SM/TotalUSERS=Percent TOTAL sect 10SM
   Then print sec2_10 SM with PercentTOTAL sec2_10 SM in text
12. If 2RPTB=8 then (1+TOTAL sec2_11 SM=TOTAL sec2_11 SM), Go to 13.
   TOTAL sec2_11SM/TotalUSERS=Percent TOTAL sec2_11 SM
   Then print sec2_11 SM with PercentTOTAL sec2_11 SM in text
13. If 2RPTC=5 then (1+TOTAL sec2_12 SM=TOTAL sec2_12 SM), Go to 14.
   TOTAL sect 12SM/TotalUSERS=Percent TOTAL sect 12SM
   Then print sec2_12 SM with PercentTOTAL sec2_12 SM in text
14. If (2RPTC=6 Or 2RPTC=7) then (1+TOTAL sec2_13 SM=TOTAL sec2_13 SM), Go to 15.
   TOTAL sec2_13 SM/TotalUSERS=Percent TOTAL sec2_13 SM
   Then print sec2_13 SM with PercentTOTAL sec2_13 SM in text
15. If 2RPTC>=8 then (1+TOTAL sec2_14 SM=TOTAL sec2_14 SM), Go to 16.
   TOTAL sec2_14 SM/TotalUSERS=Percent TOTAL sec2_14SM
   Then print sec2_14 SM with PercentTOTAL sec2_14 SM in text
16. If (2PRTA>=5 And 2PRTA<=8) then (1+TOTAL sec2_15 SM=TOTAL sec2_15 SM), Go to 17.
   TOTAL sec2_15SM/TotalUSERS=Percent TOTAL sec2_15SM
   Then print sec2_15 SM with PercentTOTAL sec2_15 SM in text
17. If (2RPTB>=3 And 2RPTB<=5) And 2PRTA<6 And 1RPTC>5 And 1RPTA>5 then (1+TOTAL sec2_16 SM=TOTAL sec2_16 SM), Go to 18.
   TOTAL sec2_16 SM/TotalUSERS=Percent TOTAL sec2_16 SM
   Then print sec2_16 SM with PercentTOTAL sec2_16 SM in text
18. If (2RPTB>=5 And 2RPTB<=7) then (1+TOTAL sec2_17 SM=TOTAL sec2_17 SM), Go to 19.
   TOTAL sect 17SM/TotalUSERS=Percent TOTAL sect 17SM
   Then print sec2_17 SM with PercentTOTAL sec2_17 SM in text
19 If (objScores.TypesOfReasoning=0 Or objScores.TypesOfReasoning=2 Or objScores.TypesOfReasoning=3) And (1RPTC>=6 And 1RPTC>=7) then (1+TOTAL sec2_18 SM=TOTAL sec2_18 SM), Go to 20.
   TOTAL sec2_18 SM/TotalUSERS=Percent TOTAL sec2_183SM
   Then print sec2_18 SM with PercentTOTAL sec2_18 SM in text
20. If (objScores.TypesOfReasoning >5) And (1RPTB>=5 And 1RPTB<=8)
   then (1+TOTAL sec2_19 SM=TOTAL sec2_19 SM), Go to 21.
      TOTAL sec2_19SM/TotalUSERS=Percent TOTAL sec2_19 SM
      Then print sec2_19 SM with PercentTOTAL sec2_19 SM in text
21. If 1RPTA>7 then (1+TOTAL sec2_20 SM=TOTAL sec2_20 SM), Go to 22.
   TOTAL sec2_20 SM/TotalUSERS=Percent TOTAL sec2_20SM
   Then print sec2_20 SM with PercentTOTAL sec2_20 SM in text
22. 2RPTB<6 And objScores.AsgnValue1E1>3
   then (1+TOTAL sec2_21 SM=TOTAL sec2_21 SM), Go to 23.
      TOTAL sec2_21 SM/TotalUSERS=Percent TOTAL sec2_21 SM
      Then print sec2_21 SM with PercentTOTAL sec2_21 SM in text
23. If (1RPTC>=6 And 1RPTC<=8 And 1RPTB>=4 And 1RPTB<=5)
   then (1+TOTAL sec2_22 SM=TOTAL sec2_22 SM), Go to 24.
      TOTAL sec2_22SM/TotalUSERS=Percent TOTAL sect 22SM
      Then print sec2_22 SM with PercentTOTAL sec2_22 SM in text
24. If objScores.AttentionBalance=1
   then (1+TOTAL sec2_23 SM=TOTAL sec2_23 SM), Go to 25.
      TOTAL sec2_23 SM/TotalUSERS=Percent TOTAL sec2_23 SM
      Then print sec2_23 SM with PercentTOTAL sec2_23 SM in text
25. If (1RPTA=6 Or 1RPTA=7) And (1RPTB=6 Or 1RPTB=7)
   then (1+TOTAL sec2_24 SM=TOTAL sec2_24 SM), Go to 26.
      TOTAL sec2_24SM/TotalUSERS=Percent TOTAL sec2_24SM
      Then print sec2_24 SM with PercentTOTAL sec2_24 SM in text
26. If ((1RPTA=7 Or 1RPTA=8) And (1RPTB=4 Or 1RPTB=5) And (1RPTC >=6 And 1RPTC<=8))
   then (1+TOTAL sec2_25 SM=TOTAL sec2_25 SM), Go to 27.
      TOTAL sec2_2_55M/TotalUSERS=Percent TOTAL sec2_25SM
      Then print sec2_255M with PercentTOTAL sec2_25 SM in text
27. If (1RPTB>5 And 2RPTB<6 And 1RPTA>4)
   Then (1+TOTAL sec2_26 SM=TOTAL sec2_26 SM), Go to 28.
      TOTAL sec2_26SM/TotalUSERS=Percent TOTAL sec2_26SM
      Then print sec2_26 SM with PercentTOTAL sec2_2_65 M in text
28. If (1RPTA<7 And 1RPTB>6 And 1RPTC>5)
   then (1+TOTAL sec2_27 SM=TOTAL sec2_27 SM), Go to 29.
      TOTAL sec2_27 SM/TotalUSERS=Percent TOTAL sec2_27 SM
      Then print sec2_27 SM with PercentTOTAL sec2_27 SM in text
29. If (2RPTB>5 And 2RPTC>5 And 2PRTA>3)
   then (1+TOTAL sec2_28 SM=TOTAL sec2_28 SM), Go to 30.
      TOTAL sect 28SM/TotalUSERS=Percent TOTAL sect 28SM
      Then print sec2_28 SM with PercentTOTAL sec2_28 SM in text
30. If (1RPTA=5 Or 1RPTA=6 then (1+TOTAL sec2_2 SM=TOTAL sec2_2 SM),
   Go to 31. TOTAL sec22SM/TotalUSERS=Percent TOTAL sec2_29 SM
      Then print sec2_2 SM with PercentTOTAL sec2_2 SM in text
31. If 1RPTA=7 then (1+TOTAL sec2_3 SM=TOTAL sec2_3 SM), Go to 32.
   TOTAL sec2_3 SM/TotalUSERS=Percent TOTAL sect 3SM
   Then print sec2_3 SM with PercentTOTAL sec2_3 SM in text
32. If (1RPTB=6 Or 1RPTB=7 then (1+TOTAL sec2_4 SM=TOTAL sec2_4 SM),
   Go to 33. TOTAL sec2_4 SM/TotalUSERS=Percent TOTAL sec2_4 SM
      Then print sec2_4 SM with PercentTOTAL sec2_4 SM in text
33. If 1RPTB>7 then (1+TOTAL sec2_5 SM=TOTAL sec2_5 SM), Go to 34.
   TOTAL sec2_5 SM/TotalUSERS=Percent TOTAL sec2_5 SM
   Then print sec2_5 SM with PercentTOTAL sec2_5 SM in text
34. If (1RPTB>=5 And 1RPTB<=7 then (1+TOTAL sec2_6 SM=TOTAL
   sec2_6 SM), Go to 35. TOTAL sec2_6 SM/TotalUSERS=Percent TOTAL
   sec2_6 SM Then print sec2_6 SM with PercentTOTAL sec2_6 SM in text
35. If (1RPTC>=5 And 1RPTC<=7) then (1+TOTAL sec2_7 SM=TOTAL sec2_7 SM), Go to 36.
   TOTAL sect 7SM/TotalUSERS=Percent TOTAL sec27SM
   Then print sec2_7 SM with PercentTOTAL sec2_7 SM in text
   36. If 1RPTC>7 then (1+TOTAL sec2_8 SM=TOTAL sec2_8 SM), Go to 37.
   TOTAL sec2_8 SM/TotalUSERS=Percent TOTAL sec2_8 SM
   Then print sec2_8 SM with PercentTOTAL sec2_8 SM in text
37. If (1RPTA>6 And 1RPTB<6 And 1RPTC<6 then (1+TOTAL sec2_9 SM=TOTAL sec2_9 SM), Go to 38
   TOTAL sec2_9 SM/TotalUSERS=Percent TOTAL sec2_9 SM
   Then print sec2_9 SM with PercentTOTAL sec2_9 SM in text

### Potential Success Reducers

38. If (2RPTA<5 And 2RPTB<5 And 2RPTC<5 And 1RPTA>5)
   then (1+TOTAL sec2_10 WM=TOTAL sec2_10 WM), Go to 39.
      TOTAL sec2_10WM/TotalUSERS=Percent TOTAL sec2_10WM
      Then print sec2_10 WM with PercentTOTAL sec2_10 WM in text
39. If (2RPTB>6 And 1RPTA<6 And 2RPTA<6 And 1RPTC>7 And
   2RPTC>6) then (1+TOTAL sec2_12 WM=TOTAL sec2_12 WM), Go
   to 40. TOTAL sec2_12 WM/TotalUSERS=Percent TOTAL sec2_12WM
   Then print sec2_12 WM with PercentTOTAL sec2_12 WM in text
40. If (2RPTA<5 And 2RPTB<5 And 2RPTC>6) then (1+TOTAL sec2_13 WM=
   TOTAL sec2_13 WM), Go to 41.
   TOTAL sect 13WM/TotalUSERS=Percent TOTAL sec2_13WM
   Then print sec2_13 WM with PercentTOTAL sec2_13 WM in text
41. If (1RPTA<6) then (1+TOTAL sec2_18 WM=TOTAL sec2_18 WM), Go to 42.
   TOTAL sec2_18 WM/TotalUSERS=Percent TOTAL sec2_18 WM
   Then print sec2_18 WM with PercentTOTAL sec2_18 WM in text
42. If (TOR>5) then (1+TOTAL sec2_19 WM=TOTAL sec2_19 WM), Go to 43.
   TOTAL sec2_19WM/TotalUSERS=Percent TOTAL sec2_19 WM
   Then print sec2_19 WM with PercentTOTAL sec2_19 WM in text
43. If (1RPTC>7 And 1RPTB<5 And 2RPTC>7 And 2RPTB<5 And 2RPTA<6 And 1RPTA>5) then (1+TOTAL sec2_1 WM=TOTAL sec2_1 WM), Go to 44. TOTAL sec21WM/TotalUSERS=Percent TOTAL sec21WM
   Then print sec2_1 WM with PercentTOTAL sec2_1 WM
44. If (2RPTA<5 And 2RPTC>7 And 2RPTB<5 then (1+TOTAL sec2_21 WM=
   TOTAL sec2_21WM), Go to 45. TOTAL sec2_21WM/TotalUSERS=Percent
   TOTAL sec2_21WM Then print sec2_21 WM
45. If (AB=0.3) then (1+TOTAL sec2_23 WM=TOTAL sec2_238 WM), Go to 46.
   TOTAL sect 23WM/TotalUSERS=Percent TOTAL sect 23WM
   Then print sec2_238 WM with PercentTOTAL sec2_23 WM in text
46. If (1RPTC>7 And 1RPTB<5 And 1RPTA>7 then (1+TOTAL sec2_2 WM=
   TOTAL sec2_2 WM), Go to 47.
   TOTAL sec2_2 WM/TotalUSERS=Percent TOTAL sec22WM
   Then print sec2_2 WM with PercentTOTAL sec2_2 WM in text
47. If (1RPTA>7 And 2RPTA<5 And 2RPTB<5 And 1RPTB<6) then (1+TOTAL sec2_3 WM=TOTAL sec2_3 WM), Go to 48.
   TOTAL sec2_3 WM/TotalUSERS=Percent TOTAL sec2_3 WM
   Then print sec2_3 WM with PercentTOTAL sec2_3 WM in text
48. If (1RPTB>6 And 1RPTC<6) then (1+TOTAL sec2_4 WM=TOTAL sec2_4 WM), Go to 49.
   TOTAL sec2_4WM/TotalUSERS=Percent TOTAL sec24WM
   Then print sec2_4 WM with PercentTOTAL sec2_4 WM in text
49. If (1RPTC<6) then (1+TOTAL sec2_6 WM=TOTAL sec2_6 WM), Go to 50.
   TOTAL sec2_6 WM/TotalUSERS=Percent TOTAL sec2_6 WM
   Then print sec2_6 WM with PercentTOTAL sec2_6 WM in text
50. If (2RPTA>=6 And 1RPTC>7 And 1RPTA<7) then (1+TOTAL sec2_8 WM=TOTAL sec2_8 WM), Go to 51.
   TOTAL sec2_8WM/TotalUSERS=Percent TOTAL sec2_8WM
   Then print sec2_8 WM with PercentTOTAL sec2_8 WM in text
51. If (1RPTA>7 And 2RPTC>7 And 2RPTB<5) then (1+TOTAL sec2_9 WM=TOTAL sec2_9 WM), Go to 52.
   TOTAL sec2_9 WM/TotalUSERS=Percent TOTAL sec2_9 WM
   Then print sec2_9 WM with PercentTOTAL sec2_9 WM in text
52. If (1RPTC>7 And 2RPTC>7 And 1RPTB<6 And 2RPTB<6 And 1RPTA>5) then (1+TOTAL sec2_20 WM=TOTAL sec2_20 WM), Go to 53.
   TOTAL sec2_20 WM/TotalUSERS=Percent TOTAL sec2_20 WM
   Then print sec2_20 WM with PercentTOTAL sec2_20 WM in text
53. If (1RPTC>7 And 1RPTB<6 And 1RPTA<6) then (1+TOTAL sec2_7 WM=TOTAL sec2_7WM), Go to 54.
   TOTAL sec2_7WM/TotalUSERS=Percent TOTAL sec2_7WM
   Then print sec2_7 WM with PercentTOTAL sec2_7 WM in text

### Dimensions Overpowering One Another

54. IF 1RPTB−1RPTA>1 then (1+TOTAL OVRPE1I1=TOTAL OVRPE1I1),
   Go to 55. TOTAL OVRPE1I1/TotalUSERS=Percent TOTAL OVRPE1I1
   Then print OVRPE1I1 with PercentTOTAL OVRPE1I1 in text
55. IF 1RPTB−1RPTC>1 then (1+TOTAL OVRPE1S1=TOTAL OVRPE1S1),
   Go to 55. TOTAL OVRPE1S1/TotalUSERS=Percent TOTAL OVRPE1S1
      Then print OVRPE1S1 with PercentTOTAL OVRPE1S1 in text
56. IF 2RPTB−2RPTA>1 then (1+TOTAL OVRPE2I2=TOTAL OVRPE2I2),
   Go to 57. TOTAL OVRPE2I2/TotalUSERS=Percent TOTAL OVRPE2I2
      Then print OVRPE2I2 with PercentTOTAL OVRPE2I2 in text
57. IF 2RPTB−2RPTC>1 then (1+TOTAL OVRPE2S2=TOTAL OVRPE2S2),
   Go to 58. TOTAL OVRPE2S2/TotalUSERS=Percent TOTAL OVRPE2S2
      Then print OVRPE2S2 with PercentTOTAL OVRPE2S2 in text
58. IF 1RPTA−1RPTB>1 then (1+TOTAL OVRPI1E=TOTAL OVRPI1E), Go to 59.
   TOTAL OVRPI1E/TotalUSERS=Percent TOTAL OVRPI1E
   Then print OVRPI1E with PercentTOTAL OVRPI1E in text
59. IF 1RPTA−2RPTA>1 then (1+TOTAL OVRPI1I2=TOTAL OVRPI1I2), Go to 60.
   TOTAL OVRPI1I2/TotalUSERS=Percent TOTAL OVRPI1I2
   Then print OVRPI1I2 with PercentTOTAL OVRPI1I2 in text
60. IF 1RPTA−1RPTC>1 then (1+TOTAL OVRPI1S1=TOTAL OVRPI1S1),
   Go to 60\1. TOTAL OVRPI1S1/TotalUSERS=Percent TOTAL OVRPI1S1
   Then print OVRPI1S1 with PercentTOTAL OVRPI1S1 in text
61, IF 2RPTA−2RPTB>1 then (1+TOTAL OVRPI2E2=TOTAL OVRPI2E2),
   Go to 62. TOTAL OVRPI2E2/TotalUSERS=Percent TOTAL OVRPI2E2
      Then print OVRPI2E2 with PercentTOTAL OVRPI2E2 in text
62. IF 1RPTC−1RPTB>1 Then print then (1+TOTAL OVRPS1E1=TOTAL
   OVRPS1E1), Go to 63. TOTAL OVRPS1E1/TotalUSERS=Percent TOTAL
   OVRPS1E1. Then print OVRPI2E2 with PercentTOTAL OVRPS1E1 in text
63. IF 1RPTC−1RPTA>1 Then print then (1+TOTAL OVR OVRPS1I1 PS1E1=
   TOTAL OVRPS1I1, Go to 64.
   TOTAL OV OVRPS1I1/TotalUSERS=Percent TOTAL OVR OVRPS1I1
   Then print OVRPS1I1 with PercentTOTAL OVRPS1I1 in text
64. IF 2RPTC−2RPTB>1 Then print then (1+TOTAL OVR OVRPS2E2 PS1E1=
   TOTAL OVRPS2E2), Go to 65.
   TOTAL OVRPS2E2/TotalUSERS=Percent TOTALOVRPS2E2
   Then print OVRPS2E2 with PercentTOTAL OVRPS2E2 in text
65. IF 2RPTC−2RPTA>1 Then print then (1+TOTAL OVR OVRPS2I2
   PS1E1=TOTAL OVRPS2I2), Go to 66.
   TOTAL OVRPS2I2/TotalUSERS=Percent TOTAL OVRPS2I2
   Then print OVRPS2I2 with PercentTOTAL OVRPS2I2 in text

### Saved User's Scores

Each test is numbered (test A=1, test B=2, etc.) which goes in front of all of the individual scores (so DIM A will be 1DIM A for that score for Test 1). For any score that incorporates the two tests, the two numbers will designated like: 12AB.
(R) notes the scores that will be stored separately, having their averages continually updated with each new user, and then analyzed for ranking in relationship to the others, enabling the identification of rarity.

| | Names of Scores | Names of Scores |
|---|---|---|
| | Test 1 | Test 1 |
| Individual's number strings | VALUE | PERCEPT |
| Dim of that dimension (R) | 1DIM A | 1PERDIMa |
| percent positive of that dimension | 1VAL A | 1PERVALa |
| Report Score for that dimension (R) | 1RPTA | 1PERRPTa |
| Adjusted Report Score | 1RPTADJA | |
| positive TORs for that dimension | 1TORA+ | |
| negative tors for that dimension | 1TORA− | |
| int for that dimension (indiv dim >2) | 1INT A | 1PERINT A |
| composition's dim for that dimension | 1CompDimA | 1PERCompDimA |
| composition's valance for that | 1CompValA | 1PERCompValA |
| dimension | | |
| composition's report score for that | 1CompRPTA | 1PERCompRPTA |
| dimension | | |
| transposition's dim for that dimension | 1TransDimA | 1PERTransDimA |
| transposition's valance for that | 1TansVALA | 1PERTansVALA |
| dimension | | |
| transposition's report score for that | 1TransRPTA | 1PERTransRPTA |
| dimension | | |
| Ratio of + rankings of A to Dif A | CT%A | |
| intrinsic compo + transpo (−1, 0, or 1) | | 1AsPERa |
| extrinsic compo + transpo (−1, 0, or 1) | | 1AsPERb |
| systemic compo + transpo (−1, 0, or 1) | | 1AsPerc |
| Dim of that dimension (R) | 1DIM B | 1PERDIMb |
| percent positive of that dimension | 1VAL B | 1PERVALb |
| Report Score for that dimension (R) | 1RPTB | 1PERRPTb |
| Adjusted Report Score | 1RPTADJB | |
| positive TORs for that dimension | 1TORB+ | |
| negative tors for that dimension | 1TORB− | |
| int for that dimension (indiv dim >2) | 1INT B | 1PERINT B |
| composition's dim for that dimension | 1CompDimB | 1PERCompDimB |
| composition's valance for that | 1CompValB | 1PERCompValB |
| dimension | | |
| composition's report score for that | 1CompRPTB | 1PERCompRPTB |
| dimension | | |
| transposition's dim for that dimension | 1TransDimB | 1PERTransDimB |
| transposition's valance for that | 1TansVALB | 1PERTansVALB |
| dimension | | |
| transposition's report score for that | 1TransRPTB | 1PERTransRPTB |
| dimension | | |
| Ratio of + rankings of B to Dif B | CT%B | |
| intrinsic compo + transpo (−1, 0, or 1) | 1BsPERa | 1BsPERa |
| extrinsic compo + transpo (−1, 0, or 1) | 1BsPERb | 1BsPERb |
| systemic compo + transpo (−1, 0, or 1) | 1BsPerc | 1BsPerc |
| Dim of that dimension (R) | 1DIM C | 1PERDIMc |
| percent positive of that dimension | 1VAL C | 1PERVALc |
| Report Score for that dimension (R) | 1RPTC | 1PERRPTc |
| Adjusted Report Score | 1RPTADJC | |
| positive TORs for that dimension | 1TORC+ | |
| negative tors for that dimension | 1TORC− | |
| int for that dimension (indiv dim >2) | 1INT C | 1PERINT C |
| composition's dim for that dimension | 1CompDimC | 1PERCompDimC |
| composition's valance for that | 1CompValC | 1PERCompValC |
| dimension | | |
| composition's report score for that | 1CompRPTC | 1PERCompRPTC |
| dimension | | |
| transposition's dim for that dimension | 1TransDimC | 1PERTransDimC |
| transposition's valance for that | 1TRansVALC | 1PERTansVALC |
| dimension | | |
| transposition's report score for that | 1TransRPTC | 1PERTransRPTC |
| dimension | | |
| Ratio of + rankings of C to Dif C | CT%C | |
| intrinsic compo + transpo (−1, 0, or 1) | | 1CsPERa |
| extrinsic compo + transpo (−1, 0, or 1) | | 1CsPERb |
| systemic compo + transpo (−1, 0, or 1) | | 1CsPerc |
| Ratio Scores: | 1RatA | 1PERRatA |
| | 1RatB | 1PERRatB |
| | 1Ratc | 1PERRatC |
| Sum of composition scores (R) | 1CompRPT | 1PERCompRPT |
| Sum of transposition scores (R) | 1TransRPT | 1PERTransRPT |
| Ratio of Composition | 1C/TRPT | 1PERC/TRPT |
| score/Transposition Score (R) | | |
| Variances (R) | 1VAR | 1PERVAR |
| Comparison Scores: | 1ComparisonA | 1PERComparisonA |
| | 1Comparisons | 1PERComparisonB |
| | 1ComparisonC | 1PERComparisonC |
| Balanced World/Self Optimism (R) | 1BWO | |
| Sense of Okness with Skepticism (R) | 1SKP | |
| Types of Reasoning for that test (R) | 1TOR | |
| total dims for that test (R) | 1DIF | |
| variance of intA and intB and intC (R) | 1VARINT1 | |
| sum of the three ints divided by the | 1INT1% | |
| 1DIF (R) | | |
| sum of abs val of the negative dims | 1AI% | |
| divided by the DIF (R) | | |
| RHO for that test (R) | 1RHO | |
| | Test 2 | Test 2 |
| | Names of Scores | Names of Scores |
| | VALUE | PERCEPT |
| Dim of that dimension (R) | 2DIM A | 2PERDIMa |
| percent positive of that dimension | 2VAL A | 2PERVALa |
| Report Score for that dimension (R) | 2RPTA | 2PERRPTa |
| Adjusted Report Score | 2RPTADJA | |
| positive TORs for that dimension | 2TORA+ | |
| negative tors for that dimension | 2TORA− | |
| int for that dimension (indiv dim >2) | 2INT A | 2PERINT A |
| composition's dim for that dimension | 2CompDimA | 2PERCompDimA |
| composition's valance for that | 2CompValA | 2PERCompValA |
| dimension | | |
| composition's report score for that | 2CompRPTA | 2PERCompRPTA |
| dimension | | |
| transposition's dim for that dimension | 2TransDimA | 2PERTransDimA |
| transposition's valance for that | 2TansVALA | 2PERTansVALA |
| dimension | | |
| transposition's report score for that | 2TransRPTA | 2PERTransRPTA |
| dimension | | |
| Ratio of + rankings of A to DifA | CT%A | |
| intrinsic compo + transpo (−1, 0, or 1) | | 2AsPERa |
| extrinsic compo + transpo (−1, 0, or 1) | | 2AsPERb |
| systemic compo + transpo (−1, 0, or 1) | | 2AsPerc |
| Dim of that dimension (R) | 2DIM B | 2PERDIMb |
| percent positive of that dimension | 2VAL B | 2PERVALb |
| Report Score for that dimension (R) | 2RPTB | 2PERRPTb |
| Adjusted Report Score | 2RPTADJB | |
| positive TORs for that dimension | 2TORB+ | |
| negative tors for that dimension | 2TORB− | |
| int for that dimension (indiv dim >2) | 2INT B | 2PERINT B |
| composition's dim for that dimension | 2CompDimB | 2PERCompDimB |
| composition's valance for that | 2CompValB | 2PERCompValB |
| dimension | | |
| composition's report score for that | 2CompRPTB | 2PERCompRPTB |
| dimension | | |
| transposition's dim for that dimension | 2TransDimB | 2PERTransDimB |
| transposition's valance for that | 2TansVALB | 2PERTansVALB |
| dimension | | |
| transposition's report score for that | 2TransRPTB | 2PERTransRPTB |
| dimension | | |
| Ratio of + rankings of B to DifB | CT%B | |
| intrinsic compo + transpo (−1, 0, or 1) | 2BsPERa | 2BsPERa |
| extrinsic compo + transpo (−1, 0, or 1) | 2BsPERb | 2BsPERb |
| systemic compo + transpo (−1, 0, or 1) | 2BsPerc | 2BsPerc |
| Dim of that dimension (R) | 2DIM C | 2PERDIMc |
| percent positive of that dimension | 2VAL C | 2PERVALc |
| Report Score for that dimension (R) | 2RPTC | 2PERRPTc |
| Adjusted Report Score | 2RPTADJC | |
| positive TORs for that dimension | 2TORC+ | |
| negative tors for that dimension | 2TORC− | |
| int for that dimension (indiv dim >2) | 2INT C | 2PERINT C |
| composition's dim for that dimension | 2CompDimC | 2PERCompDimC |
| composition's valance for that | 2CompValC | 2PERCompValC |
| dimension | | |
| composition's report score for that | 2CompRPTC | 2PERCompRPTC |
| dimension | | |
| transposition's dim for that dimension | 2TransDimC | 2PERTransDimC |
| transposition's valance for that | 2TRansVALC | 2PERTansVALC |
| dimension | | |
| transposition's report score for that | 2TransRPTC | 2PERTransRPTC |
| dimension | | |
| Ratio of + rankings of C to Dif C | CT%C | |
| intrinsic compo + transpo (−1, 0, or 1) | | 2CsPERa |
| extrinsic compo + transpo (−1, 0, or 1) | | 2CsPERb |
| systemic compo + transpo (−1, 0, or 1) | | 2CsPerc |
| Ratio Scores: | 2RatA | 2PERRatA |
| | 2RatB | 2PERRatB |
| | 2RatC | 2PERRatC |
| Sum of composition scores (R) | 2CompRPT | 2PERCompRPT |
| Sum of transposition scores (R) | 2TransRPT | 2PERTransRPT |
| Ratio of Composition | 2C/TRPT | 2PERC/TRPT |
| score/Transposition Score (R) | | |
| Variances: | 2VAR | 2PERVAR |
| Comparison Scores: | 2ComparisonA | 2PERComparisonA |
| | 2ComparisonB | 2PERComparisonB |
| | 2ComparisonC | 2PERComparisonC |
| Balanced World/Self Optimism (R) | 2BSO | |
| Sense of Okness with Skepticism (R) | 2SKP | |
| Types of Reasoning for that test | 2TOR | |
| total dims for that test (R) | 2DIF | |
| variance of intA and intB and intC (R) | 2VARINT2 | |
| sum of the three ints divided by the | 2INT2% | |
| 2DIF (R) | | |
| sum of abs val of the negative dims | 2AI% | |
| divided by the DIF (R) | | |
| RHO for that test (R) | 2RHO | |
| SCORES Regarding Both Tests: | | |
| Attention Balance (R) | 12AB | |
| Comparing Value and Percept Scores- | 12HIGHRPTSCR | |
| highest (R) | | |
| Comparing Value and Percept Scores- | 12LOWRPTSCR | |
| lowest (R) | | |
| Comparing Composition & | 12HIGHCOMPTRANS | 12PERHIGHCOMPTRANS |
| Transposition Scores (R) | | |
| Comparing Composition & | 12LOWCOMPTRANS | 12PERLOWCOMPTRANS |
| Transposition Scores (R) | | |
| Ratios of the Comparison Scores: | 12ComparisonRatA | 2PERComparisonRatA |
| World/world + self (R) | | |
| Ratios of the Comparison Scores: | 12ComparisonRatB | 12PERComparisonRatB |
| World/world + self (R) | | |
| Ratios of the Comparison Scores: | 12ComparisonRatC | 12PERComparisonRatC |
| World/world + self (R) | | |
| Ratios of the Comparison Scores: | 12ComparisonRatA | |
| World/world + self (R) | | |
| Ratios of the Comparison Scores: | 12ComparisonRatB | |
| World/world + self (R) | | |
| Ratios of the Comparison Scores: | 12ComparisonRatC | |
| World/world + self (R) | | |

### Storing the Running Averages of Defined Relationships

While some of these scores and text files are part of the first Patent, the prioritizing logic is new art, being new with this present invention and includes the old art in the scores and relationships that it is processing.

### Machine Learning Logic

Keeping track of number of users=“User”

Users+1=Users

### For Compositions and Transpositions

Keeping track of the percentage of users with composition and transposition dim for each dimension that are a total of 0 and of 1.

Logic:
If DIMCOMP_(a, b or c)=0 add to the running sum of that particular score, add this user to the total number of users, and then compute the percentage of users with a score of 0. and do the same thing for scores of 1.
   Scores with the Running Percentages:

1DIMCompAr %0 for the scores of 0, 1DIMCompBr %0, 1DIMCompCr %0,

1DIMCompAr %0 for the scores of 1, 1DIMCompBr %1, 1DIMCompCr %1

The running totals will be computed in the following ways:

| | |
|---|---|
| “A” | If 1DIMCompA>1 go to “E”, otherwise go to “B” |
| “B” | If 1DIMCompA=1 then go to “C”, otherwise go to “D” |
| “C” | (( (Users − 1) × (1DIMCompAr%0) ) +1 ) / (Users) = 1DIMCompAr%0 |
| | AND GO TO “E” |
| “D” | ( 1DIMCompA=0 ) SO PERFORM THE FOLLOWING |
| | (( (Users − 1) × (1DIMCompAr%0) ) +1 ) /( Users) = 1DIMCompAr%0 |
| “E” | If 1DIMCompB>1 go to “I”, otherwise go to “F” |
| “F” | If 1DIMCompB=1 then go to “G”, otherwise go to “H” |
| “G” | (( (Users − 1) × (1DIMCompBr%0) ) +1 ) / (Users) = 1DIMCompBr%0 |
| | AND GO TO “I” |
| “H” | (1DIMCompB=0 ) SO PERFORM THE FOLLOWING |
| | (( (Users − 1) × (1DIMCompBr%0) ) +1 ) / (Users) = 1DIMCompBr%0 |
| “I” | If 1DIMCompC>1 go to “END”, otherwise go to “J” |
| “J” | If 1DIMCompC=1 then go to “K”, otherwise go to “L” |
| “K” | (( (Users − 1) × (1DIMCompCr%0) ) +1 ) / (Users) = 1DIMCompCr%0 |
| | AND GO TO END |
| “L” | (1DIMCompC=0 ) SO PERFORM THE FOLLOWING |
| | (( (Users − 1) × (1DIMCompCr%0) ) +1 ) / (Users) = 1DIMCompCr%0 END |

This section will be repeated for Trans in place of the Comp

Example above is written “1DIMCompCr %0” now it will be “1DIMTransCr %0”

### DIF1 & DIF2

Keep running average of DIF1:

Add User's DIF1 to SumDIF1=SumDIF1
HIGHDIF1=(SumDIF1/Users)×2

RUNNING COUNT OF USERs with the 1DIF1 SCORES in one of three ranges:
1DIF1b1w7 (total 1DIF1 below 3)
1DIF1blw15 (total 1DIF1 of 3-6)
1DIF1b1w22 (total 1DIF1 of 7-9)
   INT SCORES: THE percentage of users with INT_SCORES THAT=0 FOR A, B AND C
THESE ARE CALLED “INT A %0” “INT B %0” AND “INT C %0”
THE LETTERS A, B AND C WILL BE D, E, AND F FOR TEST 2

### “A” IF 1INT A=0 THEN GO TO “B”, OTHERWISE GO TO “C”

### “B” (((INT A %0)×(USERS−1))+1)/USERS)=INT A %0

### “C” IF 1INT B=0 THEN GO TO “D”, OTHERWISE GO TO “C”

### “D” (((INT B %0)×(USERS−1))+1)/USERS)=INT B %0

### “E” IF 1INT C=0 THEN GO TO “F”, OTHERWISE GO TO “C”

### “F” (((INT C %0)×(USERS−1))+1)/USERS)=INT C %0

### “G” GO TO NEXT ROUTINE

### RHO Scores

Top 10% of RHO Scores
Machine section: Total1RHO is a list of all of the 1RHO scores that have been scored to date.
Default: Total1RHO=0.75, 0.78, 0.81, 0.82, 0.83, 0.85, 0.88, 0.90, 0.91, 0.91, 1
Sort Total1RHO from highest to lowest
0.1×Users=1RH010% (round up fraction to make 1RH010% an integer)
THEN IF 1RHO>Total1RHO score that is 1RHO10% from the highest score,
THEN 1RHO!=1, Otherwise 1RHO!=0
Add 1RHO to Total1RHO— store in Machine section END
   AB— counter for strong inner directed: If AB<0.7 then AB.3%+1=AB.3%

### Determining Standard Deviations*

Since it is unlikely that the standard deviation for a given thinking element would change from what is computed from the first 360 users (standard procedures are to have 10× the number of elements for a reliable sample and there are 18 elements in each test page and two test pages determining the results, so 360 members of the sample would be construed as reliable). Therefore it is accurate and prudent to analyze 360 users' scores to determine the standard deviations for the ranges for each score and relationship.

For each score noted with an (R) in the above lists, the database will store each of those scores in a file for the calculating of that thinking element's standard deviation. Once 360 users have been entered, the software will run a standard deviation routine on that list of 360 scores (for each element) and record the scores for that thinking element that are 1 (68%), 2 (95%), and 3 (98+%) standard deviations from the mean. After this is completed, the software will recompute the standard deviations on a periodic basis and update any scores that need to be adjusted.

What is claimed:

1. Measuring, scoring and recording the biases and clarities of compositions and transpositions within each of the six value scores of a value profile, and comparing those to each other and to their corresponding value scores.

2. Computing, interpreting, and storing the patterns and ratios to each other in each of the three value scores and each of the three valuation scores within each Frame of Reference.

3. Computing, interpreting, and storing the importance of the variance of the three value scores and the three valuation scores within each Frame of Reference, as determined in claim #2.

4. Measuring, scoring and recording the effect of the valuations acting upon their corresponding values and their effects on each other in both Frames of Reference, as determined in claim #3.

5. Identifying when and how to make appropriate adjustments of how the user's overall thinking orientations affect each of the dimensional thinking elements, using the BQR scales and the Rho scores, as determined in claim #1.

6. Computing, recording, and maintaining, as each user's profile is scored, the average scores of all users of each of the identified thinking elements and relationships and keeping current the standard deviation ranges for those scores.

7. Determining and recording, in order of significance, the user's different thinking clarities, biases and the relationships of those thinking elements based on their scores' proximity to the axiological rankings and on the rarity of those scores determined in claim #6.

8. Calling for, reviewing, and recording from the list in claim #7, those thinking orientations that are next in priority for the purpose of presenting them in reports, reviews, advice, warnings, consultant's aides, reminders and/or training and development tools.

9. Providing the computing logic to continually compute and adjust the master list of the ranges of scores that are computed in claim #7 that constitute them being rare.

10. Providing the prioritization list from claim #9 with the corresponding text fields for the computed scores and explanations for a Profile Reviewer to effectively review an individual's profile.

11. Providing prioritization and text fields and explanations from claim #10 for programming an Agent or any other technological communication device to effectively review an individual's profile.

12. Providing prioritization and text fields and explanations from claim #10 for programming an Agent or any other technological device to effectively train and certify professional profile reviewers without human intervention.

13. Generating personalized, intermittent reminders and/or development lessons sent to the user's electronic resources (phone, tablet, ipad, apple watch, Agent, SMS, text, email, videos, virtual reality headset programs, What's App programs, etc.) in order of importance/criticality that is determined in claim #10.

14. Providing directions to leaders, managers, and health care providers how best to communicate with and follow up with each user (either automatic calendaring or automatic messaging) that are determined from claim #10.

15. Providing definitions of terms and structures that are determined from claim #10 in order to be able to program technological tools that will initiate counsel and/or warnings (interjections) to the user in light of present conversations and stress levels, receiving data from the user's personal technologies: i.e. phone, earbuds, agents, fit bit, smart watch, etc.

16. Providing directions to leaders of security, police and military forces, that are determined from claim #10, directing them to be sensitive to the following possibilities (likelihoods) of identified individuals. This would direct them to watch carefully, assign specifically, and take immediate action when there is any ‘crossing the line’ by those identified as potentially prejudiced, racist, sexist, anarchistic, unable to exercise judgment when under stress, unable to control their emotions when confronted, or so rigid that they lose sight of the law and the worth of an individual when that person has broken the law.
